(19) United States
(12) Patent Application Publication
(10) Pub. No.: US 2016/0075918 A1
(43) Pub. Date: Mar. 17, 2016

(54) HYPERBRANCHED POLYALKOXYSILOXANE ADDITIVES FOR DIRT-REPELLENT SURFACE COATINGS

(71) Applicant: BYK-Chemie, GmbH, Wesel (DE)

(72) Inventors: Hans-Willi BÖGERSHAUSEN, Tonisvorst (DE); Wojciech JAUNKY, Wesel (DE); Jürgen OMEIS, Dorsten-Lembeck (DE)

(21) Appl. No.: 14/950,410

(22) Filed: Nov. 24, 2015

Related U.S. Application Data
(63) Continuation-in-part of application No. PCT/EP2014/060694, filed on May 23, 2014.

(30) Foreign Application Priority Data
May 24, 2013 (EP) 13169258.4

(51) Int. Cl. C09D 183/06; C09D 167/00

(52) U.S. Cl. CPC C09D 183/06; C09D 167/00

(57) ABSTRACT

A fluorine-free polyalkoxysiloxane, (a) having a degree of branching DB≧0.4 calculated by:

DB=(2Q⁴+Q³)/(2Q⁴+4/3Q³+2/3Q²)

in which Qⁿ is determined for n=0 to 4 using ²⁹Si-NMR, Qⁿ stands in each case for n=0 to 4 for the area below the ²⁹Si-NMR signal of a (4-n)-fold alkoxylated Si atom, and the sum of Qⁿ for n=0 to 4 is normalized to 100%, and b) produced using a non-hydrolytic polycondensation method, useful as an additive in coating agent compositions at an amount of 0.1 to 10 wt. % relating to the total weight of the coating agent composition, the coating agent composition containing at least one synthetic polymer which differs from the polyalkoxysiloxane, and in the case of a co-cross-linking reactive synthetic polymer, a crosslinking agent which differs from the polyalkoxysiloxane and from the synthetic polymer.

This application is a continuation-in-part of international patent application PCT/EP2014/060694, filed 23 May 2014, which claims priority from European Patent Application 13169258.4, filed 24 May 2013, which applications are incorporated herein by reference.

Provided are hyperbranched polyalkoxysiloxane additives for use in coating agent compositions and coatings which contain the additives and are endowed with self-cleaning properties. The compositions are useful in particular for coatings used outdoors, for example for coatings of roofs and facades which are coated by means of coil-coating or powder coating.

It is still a major challenge to provide coating agents for the building sector which yield coatings that are durable in terms of aesthetics and clean appearance. The coatings should in particular be weather-resistant and prevent the deposition of dust and dirt. In particular the facades of tall buildings are often provided with coil-coated components. Especially in geographical areas in which high atmospheric pollution is prevalent, for example in many cities and industrial areas, dirt and dust are bound by the rain and often run down on building facades at the same place, leaving dirt streaks.

However, with so-called self-cleaning surfaces, no adhesion of the dirt occurs in case of rain. Rather, dry adhering dirt is even in some cases detached from the surface in the next rainfall or by rinsing with water and is thus removed (“self-cleaning”). It is known that silicate-based coating agent compositions have good dirt-repellence. Nonetheless, this is not optimal and requires further improvement.

In the silicate-based coating agent compositions which also repel dirt, various synthetic resins are often used.

EP 0771 835 A2 discloses polyalkoxysiloxanes and a hydrolytic process for producing them and the use of the products for improving the soiling resistance, acid resistance or weathering resistance of materials. Also described are hard material coatings which can be produced from hydrolyzed solutions of the polyalkoxysiloxanes. However, the storage stability of the hydrolytically obtained polyalkoxysiloxanes and the coating materials producible therewith is not adequate. The same applies for the durability of the soiling resistance.

U.S. Pat. No. 7,037,966 B2 for example relates to dirt-resistant coatings based on compositions containing fluorinated polymer resins. These compositions contain organo-silicates and at least one water scavenger and have improved stability. As water scavengers, molecular sieves, gypsum, zeolites, alumina and/or synthetic clay materials are used. Objects which are coated with the composition should have good weather resistance, good dirt removal and good soiling resistance, without there being adverse effects on the gloss. These compositions are in particular suitable for roof materials, wall materials and other building materials for outdoors. The presence of the water scavenger is essential. Said polysiloxane additives do not have high branching and contain silanol groups. Although the coating agents have some storage stability, this is nonetheless limited.

In U.S. Pat. No. 6,486,239 B2, polyester-based coating agent compositions are described, which are used for soiling-resistant exterior panels of PCM (pre-coated metal). In particular, the polyester-based coating agent compositions for dirt-repellent PCM panels should display a good combination of physical properties such as for example surface impermeability, anticontamination action, acid resistance and self-cleaning properties. The polyalkoxysiloxane additives used are not hyperbranched and contain silanol groups. The storage stability of the compositions requires improvement.

As well as various polyalkyl(semi)metallates, WO 2004/058859 A1 also describes poly(alkoxysiloxanes) which are there also designated as polyalkyl silicates and are obtained via a non-hydrolytic synthetic process. In WO 2004/058850 A1, the poly(alkoxysiloxanes) are used in so-called nanocomposite materials or used directly from a solution for the production of coatings on glass without addition of synthetic polymers. Use thereof as an additive in minor quantities together with synthetic polymers as the main binder in coating agent compositions is not described.

ZEFFLE GH-701 is a perfluoro-organosilicate-based hydrophilization additive from DAIKIN INDUSTRIES LTD, which imparts soiling resistance to coating agents. However, for ecological reasons the use of perfluorinated additives is in principle disadvantageous and should where possible be avoided. Hence it was also a purpose of the present disclosure to provide fluorine-free additives which impart good soiling resistance.

In the journal “Progress in Organic Coatings” (1998), 33(2), 126-130, under the title “Organic-inorganic hybrid coatings for coil coating application based on polyesters and tetraethoxysilane”, Frings et al. describe organic-inorganic hybrid coating agent systems based on polyesters and tetraethoxysilane for metal substrates. The protective coatings produced therefrom should on the one hand have flexibility, if the metal substrate is subsequently shaped, and also improved hardness.

Spectroscopic and thermoanalytical studies on such systems were also performed by Frings et al. and published in “Progress in Organic Coatings” (1998), 34(1-4), 248, under the title “Hybrid organic-inorganic coatings, for coil coating applications, via the sol-gel process”. In particular, it was established that in the appropriate model system the hydroxyl groups of the polyester react with the hydroxyl groups of the hydrolyzed tetraethoxysilane. From this it was concluded that this is the cause of an elevated glass transition temperature and also has the effect that the König hardness increases with increasing silicate content of the coating system.

Furthermore, in the journal “Journal of Coatings Technology” (2000), 72 (901), 83-89, Frings et al. presented morphological studies on hybrid coating agents based on polyesters, melamine resin and various quantities of silica. Attention was in particular directed towards the effect of the silica particle size.

With regard to the problems known from the aforesaid state of the art, it is a main purpose of the present disclosure to provide additives which on the one hand impart good storage life to coating agent compositions but in particular equip the coatings produced with the coating agent compositions with improved self-cleaning properties and decreased tendency to soiling and at the same time with improved optical coating properties such as for example excellent leveling and gloss. Further-more, the additives should be fluorine-free.

Surprisingly, it was found that the aforesaid problems can be solved by addition of hyperbranched polyalkoxy-siloxanes which are obtained via a non-hydrolytic process to coating agent compositions.

The subject of the present disclosure is therefore the use of a fluorine-free polyalkoxysiloxane, which

(a) has a degree of branching DB≧0.4, which is calculated according to the following formula:

DB=(2Q⁴+Q³)/(2Q⁴+4/3Q³+2/3Q²)

wherein Qⁿ for n=0 to 4 are determined by ²⁹Si NMR and Qⁿ for n=0 to 4 in each case stands for the area under the ²⁹Si NMR signal of a (4-n)-fold alkoxylated Si atom and the sum of the Qⁿ with n=0 to 4 is normalized to 100%,

and, wherein

(b) the polyalkoxysiloxane is produced by means of a non-hydrolytic polycondensation process

as an additive in coating agent compositions in a quantity from 0.1 to 10 wt. % based on the total weight of the coating agent composition, wherein the coating agent composition contains at least one synthetic polymer selected from the group consisting of physically drying, self-crosslinking reactive or co-crosslinking reactive synthetic polymers which are different from the fluorine-free polyalkoxysiloxane, and

in the case that it is a co-crosslinking reactive synthetic polymer, a crosslinker different from the fluorine-free polyalkoxysiloxane and from the co-crosslinking synthetic polymer.

The aforesaid synthetic polymers and crosslinkers which are components of the coating agent composition in the use according to the disclosure correspond to the synthetic polymers of the component (B) or the crosslinkers (C) mentioned in the context of the description of the coating agent composition according to the disclosure. The preferred or special embodiments of the coating agent composition or of the coating agent components stated in the description of the coating agent composition according to the disclosure thus also apply for the use according to the disclosure.

The degree of branching of the polyalkoxysiloxanes, as it is used as the basis of the present disclosure, is calculated according to Frey from ²⁹Si NMR spectra (H. Frey et al., Acta Polym. 1997, 48, 30; H. Frey et al., Macromolecules 1998, 31, 3790).

For a polyethoxysiloxane (alkoxy=ethoxy) for example, each signal in the spectrum from left to right can be assigned to silicon atoms: four ethoxy groups Q⁰ (δ=82.4 ppm, TEOS=tetraethoxysilane), three ethoxy groups Q¹ (δ=−89.51 ppm, terminal units), two ethoxy groups Q² (δ=−96.86 ppm, linear units), one ethoxy group Q³ (δ=−104.7 ppm, semidendritic units) and no ethoxy groups Q⁴ (δ=−110.4 ppm, dendritic units). From the areas under the individual signals relative to the sum of the areas of the individual signals it is possible to calculate the degree of branching DB of the polyethoxysiloxane as described above.

Based on the above-defined term of the degree of branching DB=(2Q⁴+Q³)/(2Q⁴+4/3Q³+2/3Q²), those polyalkoxysiloxanes which essentially only contain doubly alkoxylated Si atoms, that is, which mainly contain [SiO₂(OR)₂] units in the polymer chain, wherein the end groups of the polymer strand are [SiO(OR)₃] units, are understood herein as “unbranched polyalkoxy-siloxanes”. The residue “OR” here stands for an alkoxy residue. The structure of these compounds are derived from those of the chain-like polysilicic acids.

Likewise based on the above-defined term degree of branching, “branched polyalkoxysiloxanes” are herein understood to mean those which additionally have triply bound [SiO₃(OR)] branching units and quadruply bound [SiO₄] branching units. The structures of these compounds can likewise be derived from those of the corresponding polysilicic acids.

In the context of the present disclosure, “hyperbranched polyalkoxysiloxanes” are understood to be those which have a degree of crosslinking ≧0.4, preferably ≧0.45 and especially preferably ≧0.5. They therefore possess a very high proportion of triply bound, singly branching [SiO₃(OR)] branching units and quadruply bound, doubly branching [SiO₄] branching units. In these hyperbranched polyalkoxysiloxanes, the [SiO₃(OR)] branching units and/or the [SiO₄] branching units are preferably on average present at every k-th middle unit of the polymer chain [SiO₂(OR)], wherein k=1 to 10, particularly preferably k=1 to 7 and quite especially preferably k=1 to 4. The structures of these compounds can be derived from those of the amorphous polysilicic acids.

In the context of the present disclosure, exclusively the hyperbranched polyalkoxysiloxanes are used as additives.

Completely linear polymers, that is completely “unbranched polyalkoxysiloxanes”, have a degree of branching of 0%, on the other hand, perfect dendrimers have a degree of branching of 100%. In the context of the present disclosure, those which have a degree of branching of <40% and >0% are understood to be “branched polyalkoxysiloxanes”, and those which have a degree of branching ≧40% (that is ≧0.4) as “hyperbranched polyalkoxysiloxanes”.

In the context of the present disclosure, the term “additive” is understood to mean the use of the fluorine-free polyalkoxysiloxane in minor quantities from 0.1 to 10 wt. %, preferably 0.5 to 5 wt. % and particularly preferably 1 to 2 wt. % based on the total weight of the coating agent composition. The use purpose of the “additives” according to the present disclosure consists in particular in the alteration of the surface properties of the coatings produced from the coating agents. Hence they are preferably additives for alteration of the surface properties of coating agent compositions, particularly preferably additives for increasing or decreasing the surface energy of the coating agent compositions and/or increasing the surface hardness of the coatings. Quite especially preferably, they are additives for preventing or impeding surface soiling, such as for example anti-graffiti additives. Further properties or use purposes of the additives follow from the detailed description of the present disclosure and from the examples.

In the state of the art, polyalkoxysiloxane are usually obtained by methods known per se, such as for example the hydrolytic condensation of various starting compounds, for example tetraalkoxysilanes, such as for example tetraethoxysilane (TEOS) or tetramethoxysilane (TMOS) or mixtures thereof in the presence of non-stoichiometric quantities of water and in the presence of an acid, such as for example sulfuric acid or hydrochloric acid or a basic catalyst, such as for example triethanolamine. If this method is followed, the polyalkoxysiloxanes thus obtained contain not insignificant quantities of free silanol groups (Si—OH). The remaining silanol groups can enter into further condensation reactions and adversely affect the properties of the polysiloxanes, in particular the desired effects thereof after storage, the storage stability of the polyalkoxysiloxanes itself or of the coating agent compositions produced therefrom.

The hyperbranched polyalkoxysiloxanes used according to the disclosure or those used in the compositions according to the disclosure are produced by means of non-hydrolytic methods which on the one hand result in hyperbranched products, and on the other hand proceed with no or almost no silanol group formation. If a polycondensation method as described below is used to produce the polyalkoxysiloxanes, then this has a surprisingly positive effect on the storage stability of the additive and also on the storage stability of the resulting coating agent compositions which contain this additive.

The degree of branching of the products obtained is ≧0.40, preferably ≧0.45 and especially preferably ≧0.5.

In order to obtain products free from free silanol groups or almost free from free silanol groups, a suitable, non-hydrolytic method must be used. An example of such a non-hydrolytic polycondensation method for the production of hyperbranched polysiloxane polycondensates is described in “One-Pot Synthesis of Hyperbranched Polyethoxy-siloxanes”, Macromolecules (2006), 39(5), 1701-1708, or for example in WO 2004/058859 A1. The synthesis route is based on a condensation reaction of a polyalkoxysilane with an acid anhydride at a temperature of about 70° C. to 120° C. in presence of an organotitanium catalyst. Explicitly, a mole ratio of acetic anhydride to tetraethoxysilane from 1.0 to 1.3, preferably from 1.1 to 1.25, is used. In this manner, a stable and hyperbranched polyalkoxysiloxane which is essentially free from silanol groups can be obtained. Such a hyperbranched polyalkoxysiloxane can be used as an additive in the present application.

To perform suitable polycondensation reactions which lead to the polyalkoxysiloxanes to be used according to the disclosure, monomeric alkoxysilanes or mixtures thereof, oligomeric alkoxysiloxanes or mixtures thereof, or mixtures of monomeric alkoxysilanes with oligomeric alkoxysiloxanes can preferably be used.

Particularly suitable monomeric alkoxysilanes or oligomeric alkoxysiloxanes which can be used for the production of the polyalkoxysiloxanes to be used according to the disclosure can be described by the following generic formula (I):

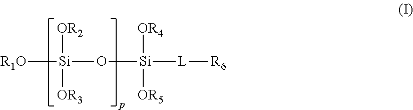

wherein R₁, R₂, R₃, R₄ and R₅ independently of one another are linear or branched alkyl groups with 1 to 4 carbon atoms, preferably one or two carbon atoms and p represents a whole number from 0 to 15, preferably 0 to 8 and especially preferably 0 to 5. With the use of monomeric alkoxysilanes alone, p=0. If p≠0, that is p≧1, then these are oligomeric polysiloxanes. In a preferred embodiment, p=0. In a further preferred embodiment, p stands for 1 to 15, preferably 1 to 8 and especially preferably 1 to 5. However, mixtures of various compounds of the formula (I) can also be used. In such mixtures, compounds with p=1 and compounds with p≧1 can be present.

L stands for oxygen or a divalent linking group, for example an alkylene group with one to six carbon atoms. L preferably stands for an ethylene or propylene group.

R₆ independently stands for a linear or branched alkyl group with 1 to 5 carbon atoms, preferably with one or two carbon atoms, for a polyalkyleneoxy group, such as for example a polyethyleneoxy group, polypropyleneoxy group, poly(ethyleneoxy/propyleneoxy) group wherein the ethyleneoxy and propyleneoxy units are arranged randomly or in blocks in the copolymer, for a polysiloxane group or for a polyalkyleneoxy-polysiloxane group or for a functional group such as for example an isocyanate group, epoxy group, amino group, vinyl group, allyl group, acryl group or (meth)acryl group.

L is preferably oxygen and R₆ independently thereof preferably stands for an alkyl group with one to five carbon atoms, preferably with one or two carbon atoms.

Specific monomeric alkoxysilanes of the structure (I) include tetraethyl orthosilicate, tetramethyl ortho-silicate, 2-methoxyethyl orthosilicate, 1-methoxy-propanol 2-orthosilicate, tetrabutyl orthosilicate, n-propyl orthosilicate or polyalkylene oxide alkoxysilane or mixtures of the aforesaid compounds.

Specific oligomeric alkoxysiloxanes are oligoalkoxy-silanes of the structure (I), where these are for example oligomers of tetraethyl orthosilicate, tetramethyl orthosilicate, 2-methoxyethyl orthosilicate, 1-methoxy-propanol 2-orthosilicate, tetrabutyl orthosilicate, n-propyl orthosilicate or polyalkylene oxide alkoxysilane or mixtures thereof.

Examples of commercially available monomeric alkoxy-silanes are tetramethoxysilane (=TMOS, METHYL SILICATE 39, available from Colcoat Co., Ltd.), tetraethoxysilane (=TEOS; Dynasylan® A, obtainable from Evonik Industries) and ETHYL SILICATE 28 (available from Colcoat Co., Ltd.).

The introduction of functional groups into residue R₆ is preferably effected via the use of silanes which bear one of the groups selected from isocyanate groups, epoxy groups, amino groups, vinyl groups, allyl groups or (meth)acryl groups. Silanes suitable for this are for example 3-isocyanatopropyltriethoxysilane, 3-glycidoxy-propyltrimethoxysilane, 2-(3,4-epoxycyclohexyl)ethyl-triethoxysilane, 3-aminopropyltriethoxysilane, 3-N-methyl-3-aminopropyl triethoxysilanes, N-(2-aminoethyl)-3-aminopropyl trimethoxysilane, vinyltriethoxysilane, allyltrimethoxysilane or 3-methacryloxypropyltrimethoxy-silanes.

Examples of commercially available functional alkoxy-silanes are for example 3-isocyanatopropyltriethoxy-silanes (Silquest A-1310 (Momentive Performance Materials), 3-aminopropyltrimethoxysilane (Dynasylan AMMO (Evonik)), N-(2-aminoethyl)-3-aminopropyl trimethoxy-silane (Dynasylan DAMO (Evonik)), 3-glycidylpropyl-triethoxysilane (Dynasylan GLYEO, Evonik)), glycidyl-propyltrimethoxysilane (Dynasylan GLYMO (Evonik)), vinyltrimethoxysilane (Dynasylan VTMO (Evonik)), vinyltriethoxysilane (Dynasylan VTEO Evonik)) and 3-methacryloxypropyltrimethoxysilanes (Dynasylan MEMO (Evonik)).

Silane derivatives of the polydimethylsiloxane or polyethylene glycol are usually designated as polydimethylsiloxane alkoxysilanes or polyalkylene oxide alkoxysilanes. A typical example is poly[oxy(dimethyl-silylene)], α-(butyldimethylsilyl)-ω-[[dimethyl[2-(triethoxysilyl)ethyl]silyl]oxy]- or poly(oxy-1,2-ethanediyl), α-methyl-ω-[3-(trimethoxysilyl)propoxy]- (available as Silquest A-1230 from Momentive Performance Materials).

Examples of commercially available oligomeric alkoxysiloxanes are for example methyl silicates 51 (p=5) (from Colcoat Co., Ltd.), Dynasylan 40 (from the firm Evonik-Degussa) or ETHYL SILICATE 40 (p=4), ETHYL SILICATE 45 (p=8) or ETHYL SILICATE 48 (p≧10) (all commercially available from Colcoat Co., Ltd.).

The hyperbranched fluorine-free polyalkoxysiloxanes usable according to the disclosure also include those which after the polycondensation reaction described above are further modified in order to optimize their compatibility with the particular coating agent composition.

After the polycondensation reaction, the alkoxy groups of the Si-alkoxy groups of the hyperbranched polyalkoxysiloxane can be wholly or partially reacted by condensation with monohydroxy functional alcohols and monohydroxy functional polyethers or monohydroxy functional polysiloxane compounds such as monohydroxy functional polysiloxanes or monohydroxy polyether-modified polysiloxanes. Thereby, the original alkoxy groups are cleaved off with formation of the corresponding alcohols and replaced by the monohydroxy functional alcohols, monohydroxy functional polyethers or monohydroxy functional polysiloxanes or monohydroxy polyether modified polysiloxanes, such as for example monohydroxy functional polyalkyleneoxy-polysiloxanes. This substitution reaction can be described as trans-alkoxylation.

As monohydroxy functional alcohols, those which are linear or branched and have 3 to 20, preferably 3 to 12 and especially preferably 3 to 10 carbon atoms are preferred, such as for example propanol, butanol, hexanol, octanol, isopropanol, isobutanol, 2-ethylhexyl alcohol or isononanol. If for example hyperbranched polyalkoxysiloxanes originally containing ethoxy groups are obtained, then by subsequent reaction with for example butanol, the ethoxy groups can be replaced by butoxy groups.

As monohydroxy functional polyethers, those mono-ols which comprise alkyl-, alkenyl-, aryl- or aralkyl-polyalkylene oxides, wherein the alkylene oxide is an ethylene oxide, propylene oxide or butylene oxide or a mixture thereof and wherein the polyether mono-ols preferably have a number average molecular weight of 120 to 750 g/mol are suitable. Examples of these are polyethylene glycol allyl ethers, polyethylene glycol monomethyl ethers, polyethylene glycol monobutyl ethers or polypropylene glycol monomethyl ethers.

As monohydroxy functional polysiloxanes or monohydroxy polyether modified polysiloxanes, those which are linear or branched, such as for example monohydroxy functional polydimethylsiloxanes, monohydroxy functional polyethylene glycol polydimethylsiloxanes, monohydroxy functional polypropylene glycol polydimethylsiloxanes and monohydroxy functional polyethylene glycol/polypropylene glycol polydimethylsiloxanes, in each case with a number average molecular weight of preferably 280 to 900 g/mol, are preferred.

The alkoxy substitution reaction (transalkoxylation) can be effected by addition of the alcohol or polyether mono-ol to the hyperbranched polyalkoxysiloxane, wherein the addition is possible into the same reactor in which unmodified hyperbranched polyalkoxysiloxane was at first produced. The alcohol cleaved off can be distilled off in the process.

After or during the polycondensation reaction, the alkoxy groups of the Si-alkoxy groups of the hyperbranched polyalkoxysiloxane can also be wholly or partially reacted by condensation with alkoxysilane-linked polysiloxanes and/or alkoxysilane-linked polyalkyleneoxy polysiloxanes and/or alkoxysilane-linked polyethers and/or alkoxysilanes which bear functional groups such as epoxy groups, amino groups, vinyl groups, allyl groups and/or (meth)acryl groups. The condensation with a polydimethyl-siloxane alkoxysilane and/or polyalkylene oxide alkoxysilane is especially preferred.

Therefore, in a particular embodiment, the polyalkoxysiloxanes to be used according to the disclosure, during or after their synthesis, are brought into reaction with polydialkylsiloxanes bearing hydrolyzable silane groups, in order for example to equip the coatings produced with the coating agent compositions according to the disclosure with hydrophobic properties. As hydrolyzable silane groups, alkoxysilane groups such as for example methoxysilane groups or ethoxysilane groups in particular are suitable, but for example acetoxysilane groups can also be used. Preferred polydialkylsiloxanes are polydimethylsiloxanes.

In a further particular, the polyalkoxysiloxanes to be used according to the disclosure, during or after their synthesis, are brought into reaction with polyalkylene oxides bearing hydrolyzable silane groups, in order for example to equip the coatings produced with the coating agent compositions according to the disclosure with hydrophilic properties. Hydrophilic properties are in particular obtained by modification of the polysiloxanes with polyethylene oxides (polyethylene glycols) bearing hydrolyzable silane groups. However, mixed polyalkylene oxides of ethylene oxide and/or propylene oxide and/or butylene oxides which bear hydrolyzable silane groups can also be used for the modification. While pure polyethylene oxides are hydrophilic, pure polypropylene oxides or indeed polybutylene oxides are more hydrophobic or even exclusively hydrophobic. However, in order to lower the hydrophilicity of pure polyethylene oxides, mixed polymers thereof with propylene oxide and/or butylene oxide can be used. As hydrolyzable silane groups, those mentioned in the previous paragraph are in particular suitable.

The hyperbranched polyalkoxysiloxanes which can be used in the present disclosure preferably have a weight average molecular weight in the range from 1000 to 7000 g/mol and especially preferably from 1200 to 4000 g/mol. If the weight average molecular weight is less than 1000 g/mol or if it is higher than 7000 g/mol, then the segregation of the hyperbranched polyalkoxysiloxanes at the air/coating agent interface is usually diminished, as a result of which the desired effects are diminished.

Although the aforesaid production process provides a polyalkoxysiloxane additive which has no or almost no silanol groups, it is absolutely not excluded that the additive comes into contact with atmospheric moisture during the packaging step or during storage. This would in turn lead to hydrolysis of some alkoxy groups with formation of the undesired silanol groups. Hence water scavengers, such as for example 1,1-dimethoxypropane, the cyclic acetal 2-methyl-1,3-dioxolan, ketals such as for example 2,2-dimethoxypropane, 2,2-diethoxypropane and 2,2-dimethoxybutane or silanes such as vinyltrimethoxy-silane, octyltrimethoxysilane, or dimethoxydimethyl-silane, which absorb the atmospheric moisture and thereby effectively prevent a reaction with the polyalkoxy-siloxane usable according to the disclosure, can be used. The quantity of water scavenger used is preferably 0.1-5 wt. %, especially preferably 0.5-2.5 wt. %, based on the polyalkoxysiloxane.

The polyalkoxysiloxane additive is preferably packed under an inert gas atmosphere, especially preferably nitrogen.

The hyperbranched polyalkoxysiloxanes can be provided in solid form, preferably as solid, encapsulated additive, solid freeze-dried additive or solid, wax-containing or waxy substance-containing additive. In the context of the present disclosure, the term “solid” means that the additive is in solid form at room temperature, i.e. 23° C.

This can for example be effected through absorption on a porous carrier material such as a porous silicic acid carrier or porous polyolefins such as Accurel® from Membrana or by mixing with a polymer or wax or a waxy compound or by encapsulation.

A further subject of the present disclosure is a solid, freeze-dried additive comprising (i) at least one fluorine-free polyalkoxysiloxane as defined above and (ii) at least one polymer, wherein this is producible by (iii) production of a solution of (i) and (ii) in a suitable solvent and (iv) removal of the solvent by freeze-drying. Preferably, the solid, freeze-dried additive contains at least 50 wt. % of (i) based on the total weight of the additive. In order to produce a solid, freeze-dried additive, the polyalkoxysiloxane additive can be dissolved in a suitable solvent for example with a polymer such as for example polystyrene, be lyophilized (=freeze-dried) and optionally then milled to a solid powder. A suitable solvent is a solvent in which both the polyalkoxysiloxane additive and also the polymer dissolves and which behaves essentially inertly towards the dissolved compounds.

A further subject of the present disclosure is a wax-containing or waxy substance-containing additive, comprising (i) at least one fluorine-free polyalkoxy-siloxane as defined above and (ii) at least one wax or a waxy substance, and which is producible by (iii) melting the wax or the waxy substance, (iv) addition of (i), subsequent (v) cooling and (vi) optionally pelleting or granulation. The solid, wax-containing or waxy substance-containing additive preferably contains at least 50 wt. % of (i) based on the total weight of the additive. As wax or waxy substances, for example fatty acids or esters of fatty acids, fatty alcohols or ethoxylated fatty alcohols are suitable.

The hyperbranched polyalkoxysiloxane is preferably provided in solid, encapsulated form. A further subject of the disclosure is therefore a solid, encapsulated additive comprising (i) at least one fluorine-free polyalkoxysiloxane as defined above and (ii) at least one polymer which serves for the encapsulation of the fluorine-free polyalkoxysiloxane. A solid, encapsulated additive is for example obtainable by dissolution of (i) and (ii) in a nonpolar solvent, addition of a solution of (i) and (ii) to a polar solvent which contains an emulsifier, removal of the nonpolar solvent and separation of the solid, encapsulated additive. The solid, encapsulated additive preferably contains at least 50 wt. % of (i) based on the total weight of the additive.

In order to obtain encapsulated forms of the hyper-branched polyalkoxysiloxane, an emulsion method as previously described can be used. This method is based on the mixing of two insoluble phases, a nonpolar and a polar phase. The hyperbranched polyalkoxysiloxanes are dissolved in a nonpolar phase, just like the polymer which is capable of forming microcapsules and is compatible with the coating agent composition. As polymers suitable for this, for example polystyrene, polypropylene, polymethylpentene, poly(ethyl methacrylate), poly(methyl methacrylate), methyl methacrylate/ethyl methacrylate copolymer, or urea resins such as for example urea-formaldehyde resins, urea-acetaldehyde resins, urea-propionaldehyde resins, urea-butyraldehyde resins and crosslinked polyurea, based on polyethyleneimine, or melamine resins such as for example melamine-formaldehyde resins, melamine-acetaldehyde resins, melamine-propionaldehyde resins and melamine-butyraldehyde resins can be mentioned.

If a volatile solvent is selected as the nonpolar phase, then the encapsulation polymer precipitates when the nonpolar phase disappears gradually with continuous stirring of the mixture. When the whole nonpolar phase has been evaporated, the microcapsules can be removed by filtration. This method is an inexpensive method which requires no expensive equipment and operates without many process steps. Furthermore, the polymer which forms the microcapsules (encapsulation polymer) can be an inexpensive compound, as can the nonpolar and polar liquids which are used for the emulsion formation.

For the production of the microcapsules, the hyper-branched polyalkoxysiloxane and the microcapsule-forming polymer are weighed out and dissolved in a nonpolar solvent. An emulsifier is dissolved in a polar solvent and the hyperbranched polysiloxane and the microcapsule-forming polymer dissolved in the nonpolar solvent are gradually added to the solution of the emulsifier in the polar solvent. As emulsifiers, for example polyalkylene oxide copolymers, fatty alcohols, alkoxylated fatty alcohols, fatty acids, alkoxylated fatty acids, fatty acid esters of polyols, sorbitan fatty acid esters, saccharose fatty acid esters, or silicone surfactants which do not fall under the definition of the polyalkoxysiloxanes according to the disclosure are suitable. In the process, the emulsion is stirred, the nonpolar phase removed under reduced pressure and the microcapsules formed are removed by filtration, then washed and dried and packed. The shell of the microcapsules protects the polyalkoxysiloxane from hydrolysis during storage and thus from atmospheric humidity. The polyalkoxysiloxane-laden microcapsules are also stable at elevated temperatures, for example temperatures of up to 60° C. Above a certain temperature, the polymeric microcapsule shell melts or splits and the encapsulated polyalkoxysiloxane additive is released. The loading of the microcapsules with the polyalkoxysiloxane additive is preferably at least 30 wt. %, especially preferably at least 40 wt. % and quite especially preferably at least 50 wt. %, based on the weight of the microcapsules.

The microcapsules can for example be mixed with a powder coating material and impart increased storage stability to the mixture.

A further subject of the present disclosure are coating agent compositions which have had the hyperbranched polyalkoxysiloxanes to be used according to the disclosure added to them, namely coating agent compositions which contain (A) 0.1 to 10 wt. %, based on the coating agent composition, of a fluorine-free polyalkoxysiloxane which has a degree of branching DB≧0.4, which is calculated according to the following formula: DB=(2Q⁴+Q³)/(2Q⁴+4/3Q³+2/3Q²) wherein Qⁿ for n=0 to 4 are determined by ²⁹Si NMR and Qⁿ for n=0 to 4 in each case stands for the area under the ²⁹Si NMR signal of a (4-n)-fold alkoxylated Si atom and the sum of the Qⁿ with n=0 to 4 is normalized to 100%, and the polyalkoxysiloxane is produced by means of a non-hydrolytic polycondensation process; and (B) at least one synthetic polymer selected from the group consisting of physically drying, self-crosslinking reactive or co-crosslinking reactive synthetic polymers which are different from (A), and (C) in the case that (B) is a co-crosslinking reactive synthetic polymer, a crosslinker different from (A) and (B).

The coating agent compositions are preferably those which are usable in coil coating methods or powder coating methods. The coating agent compositions can be liquid or solid (powder coating agents). Powder coating agent particles can however also be used in the form of so-called slurries, that is in the form of a suspension.

As well as the hyperbranched polyalkoxysiloxane additive, the coating agent compositions according to the disclosure contain at least one synthetic resin as the main binder, preferably in a quantity greater than 10 wt. % based on the total weight of the coating agent. The synthetic resin (synthetic polymer) can for example be physically drying, self-crosslinking reactive or co-crosslinking reactive, wherein in the latter case at least one further crosslinker which has complementary reactive groups to the main binder is present. However, as synthetic resins, those which are self-crosslinking and also co-crosslinking, that is which can enter into reactions with substances similar to themselves and also with crosslinkers can also be used.

“Physically drying” synthetic resins are understood to be those which without further reaction with themselves or crosslinkers form a coating agent film merely on evaporation of the solvent from the coating agent system.

Radiation-curable resins, which preferably contain ethylenically unsaturated groups, such as for example acrylate groups or methacrylate groups, can also be used as synthetic resins in the sense of the present disclosure. These can for example be crosslinked by UV radiation or electron radiation. If such a resin is used as the only radiation-curable resin, then self-crosslinking takes place. However, with combined use of for example monomeric or dimeric reactive diluents with the radiation-curable resin, a crosslinking with the reactive diluents and thus a co-crosslinking can additionally take place. Hence in such systems the reactive diluents act not only as diluents to establish a defined processing viscosity, but also as cross linkers.

Examples of synthetic resins which are usable in the coating agents, to which the polyalkoxysiloxane additive can be added, are preferably selected from the known resin components, such as for example fluorinated resins, acrylic resins, silicone-modified acrylic resins, urethane resins, melamine resins, silicone resins, epoxy resins, polyester resins, radiation-curable resins and the like.

The hyperbranched polyalkoxysiloxanes can be simply and homogeneously incorporated into the synthetic resin-containing coating composition in a wide concentration range by admixture. The coatings obtained therefrom are essentially defect-free. The polyalkoxysiloxanes can also be used in the modified form described above, that is by subsequent reaction with monohydroxy functional alcohols or monohydroxy functional polyethers, in order to achieve fine adjustment of the compatibility with the binders, or to improve the spreading, the gloss or the transparency of the coatings. In contrast to monomeric tetraethoxysilanes, the hyperbranched polyalkoxysiloxane additives are not lost through evaporation during the coating process.

The coating compositions according to the disclosure contain at least one hyperbranched polyalkoxysiloxane. The polyalkoxysiloxane additive is added to the composition which contains the synthetic resin in a quantity from 0.1 to 10 wt. % and preferably in a quantity from 0.5 to 5 wt. % and quite especially preferably in a quantity from 1 to 2 wt. % as active substance. With the use of microcapsules, the hyperbranched polyalkoxysiloxane contained therein is understood as the active substance.

Particular with use in powder coating agent compositions, use of the hyperbranched polyalkoxysiloxane in solid form, in particular in a form absorbed on a solid carrier material or advantageously in micro-encapsulated form, is advisable.

In a preferred embodiment, coil coating methods and powder coating methods are preferably used, and the synthetic resins suitable for this are those which cure at temperatures of preferably more than 100° C. particularly preferably more than 140° C. and quite especially preferably more than 180° C. The coating agents for example include coil and powder coating agents based on acrylic resins, polyester resins, polyurethane resins, epoxy resins and fluorinated polymers.

In the context of the present disclosure, co-crosslinking polyhydroxy functional binders are preferably used, such as for example polyhydroxy functional polyesters, which react with a crosslinker which bears groups reactive towards hydroxy groups. Suitable crosslinkers are for example blocked or unblocked polyisocyanates and aminoplast resins, such as for example melamine resins or beta-hydroxyalkylamides (obtainable under the trade-mark

Primid® of the company Ems Chemie) or radiation-curable diluents. However, epoxy resins which can cure with dicyandiamide crosslinkers or amines can also be used as binder/crosslinker systems.

The polyalkoxysiloxane additives can be used together with usual coating agent components, such as for example pigments, wetting agents and dispersants, surface active additives, such as for example leveling agents, fillers, rheology-controlling additives or bonding agents and the like.

Polyalkoxysiloxanes which are produced by the non-hydrolytic method have a higher tendency to migrate and orientate themselves on the surface of the coating agents towards the air. By contact with atmospheric water or rain, a silicic acid network is formed. This highly crosslinked silicon network in the upper layer of the coating agent film prevents contaminating substances from penetrating into the surface. The flexibility of the coating film, in particular when this is applied in the context of a multilayer coating, is maintained. This is essential in particular during processing by means of coil coating.

It is presumed that the highly crosslinked polyalkoxy-siloxane network forms a silicic acid network which is present interpenetrated with the organic network of the organic resin and thus to form an inorganic-organic hybrid coating equipped with improved dirt-repellent properties. Herein, the term “hybrid coating” designates inorganic-organic coating agent compositions which are obtained by application of the compositions according to the disclosure and which comprise a mixture of a synthetic resin composition and the polyalkoxysiloxane additive.

The coating agents which contain the hyperbranched polyalkoxysiloxanes exhibit migration of the polyalkoxysiloxane to the surface of the coating agent, simultaneously with the solvent evaporation during the stoving process. The hyperbranched polyalkoxysiloxanes separate out on the surface and there form a layer which crosslinks by hydrolysis. In this, the alkoxysilyl groups are hydrolyzed and form a silicic acid network through condensation reactions and some formation of non-condensed silanol groups, whereby the latter increase the hydrophilicity of the surface and decrease the water contact angle.

Hence a silicic acid network is present in the surface region of the cured coatings. As a result, the surface becomes harder and more hydrophilic and allows better wetting with water, which has the beneficial effect that dirt which adheres to the hybrid coating can more easily be rinsed off with water.

As described above, the polyalkoxysiloxanes used according to the disclosure can also be modified in order to control the hydrophobicity of coatings. Through the use of polyalkoxysiloxanes modified with polysiloxanes, the surface energy can be reduced and the hydrophobicity of coatings increased. The surface can be configured more hydrophobic so that adhesion to this surface is decreased as a result of which dirt-repellent, easy-to-clean surfaces can be obtained. In general, through reduction of the surface energy, more hydrophobic surfaces are obtained which are more difficult to wet and repel water, oil and dirt, or display anti-adhesive and anti-graffiti properties.

The coating agent compositions according to the disclosure are preferably suitable for anti-graffiti coatings, release coatings, self-cleaning facade coatings, icing-preventing coatings, in particular for aircraft, dirt-repellent coatings for automobile bodywork or light metal wheel rims, dirt-repellent machinery and equipment coatings, dirt-repellent furniture coatings or ship coatings such as for example antifouling coatings.

Owing to the exceptionally good antiadhesive action of the coating agent compositions according to the disclosure, even oily substances such as mineral oils, plant oils or oily preparations are repelled, so that containers coated therewith can be completely emptied. Accordingly, coating agent compositions with additives added according to the disclosure are extremely suitable as internal coating materials for coating of drums, canisters or cans.

Owing to the outstanding compatibility of the branched polyalkoxysiloxanes according to the disclosure with various paint systems, these are extremely suitable for producing transparent coatings.

Also a subject of the disclosure is a method for coating a substrate selected from the materials metal, glass, ceramic and plastic, wherein a coating agent composition according to the disclosure is applied onto the substrate, is crosslinked by physical drying, by reactive self-crosslinking or reactive co-crosslinking. Preferably, a thermal crosslinking is effected at a temperature >100° C. A further subject of the disclosure is the cured coating thus obtained. In a particular embodiment, on the cured coating, an at least partial hydrolytic crosslinking of the hyperbranched polyalkoxysiloxanes takes place on the coating surface with formation of a silicic acid network.

Cured coatings are as a rule thermoset and thus differ drastically for example from thermoplastic materials.

By use of the coating agents according to the disclosure, it is possible markedly to improve the self-cleaning properties of the surfaces. A further advantage is that other properties of such hybrid coatings, such as for example the leveling, the gloss, the transparency and flexibility are not adversely affected and the aforesaid properties are even to some extent improved.

The invention will be illustrated below on the basis of examples.

### EXAMPLES

### Synthesis Examples

### Example 1

### Hyperbranched Polyethoxysiloxane

416.68 g (2.0 mol) of tetraethoxysilane, 224.61 g (2.2 mol) of acetic anhydride and 1.72 g (4.25 mmol) of tetrakis(trimethylsiloxy)titanium were weighed into a 1000 ml 4-necked flask equipped with stirrer, thermometer, Vigreux column and distillation head with collection flasks, homogenized under a nitrogen atmosphere and heated until distillate passed over. The distillation was continued until at a temperature of 133° C. no more distillate passed over. Next, distillation was performed for 1.5 hrs on the rotary evaporator at 120° C. (5 mbar).

Characterization of the product by gel permeation chromatography and ²⁹Si NMR gave:

GPC: M_{w} 2990 g/mol, Mₙ 893 g/mol, P_{d} 3.34

²⁹Si NMR: Q₀: 2%, Q₁: 18%, Q₂: 41%, Q₃: 30%, Q₄: 9% DB=0.56

### Example 2

### Methoxypolyethylene Glycol-Modified Hyperbranched Polyethoxysiloxane

416.68 g (2.0 mol) of tetraethoxysilane, 224.61 g (2.2 mol) of acetic anhydride and 1.72 g (4.25 mmol) of tetrakis(trimethylsiloxy)titanium were weighed into a 1000 ml 4-necked flask equipped with stirrer, thermometer, Vigreux column and distillation head with collection flasks, homogenized under a nitrogen atmosphere and heated until distillate passed over. The distillation was continued until at a temperature of 133° C. no more distillate passed over. 70.0 g (0.2 mol) of methoxypolyethylene glycol of a molecular weight of 350 g/mol (MPEG 350) were added and distillation carried out until at 133° C. no more distillate passed over. Next, distillation was performed for 1.5 hrs on the rotary evaporator at 120° C. (5 mbar).

Characterization of the product by gel permeation chromatography gave:

GPC: M_{w} 3136 g/mol, Mₙ 822 g/mol, P_{d} 3.81

²⁹Si NMR: Q₀: 2%, Q₁: 18%, Q₂: 41%, Q₃: 30%, Q₄: 9% DB=0.56

### Example 3

### Methoxyethoxy-Modified Hyperbranched Polyethoxysiloxane

78.0 g of the substance produced in example 1 and 22.0 g (0.289 mol) of methyl glycol were weighed into a 250 ml 4-necked flask equipped with stirrer, thermometer, (100 mm) dephlegmator and distillation head with collection flasks, homogenized under a nitrogen atmosphere and heated until distillate passed over. The distillation was continued until at a temperature of 133° C. no more distillate passed over. Next, distillation was performed for 1.5 hrs on the rotary evaporator at 120° C. (5 mbar).

Characterization of the product by gel permeation chromatography gave:

GPC: M_{w} 3136 g/mol, Mₙ 896 g/mol, P_{d} 3.5

²⁹Si NMR: Q₀: 2%, Q₁: 18%, Q₂: 41%, Q₃: 30%, Q₄: 9% DB=0.56

### Example 4

### Phenoxyethoxy-Modified Hyperbranched Polyethoxysiloxane

78.0 g of the substance produced in example 1 and 22.0 g (0.159 mol) of monophenyl glycol were weighed into a 250 ml 4-necked flask equipped with stirrer, thermometer, (100 mm) dephlegmator and distillation head with collection flasks, homogenized under a nitrogen atmosphere and heated until distillate passed over. The distillation was continued until at a temperature of 133° C. no more distillate passed over. Next, distillation was performed for 1.5 hrs on the rotary evaporator at 120° C. (5 mbar).

Characterization of the product by gel permeation chromatography gave:

GPC: M_{w} 3820 g/mol, Mₙ 1051 g/mol, P_{d} 3.63

²⁹Si NMR: Q₀: 2%, Q₁: 18%, Q₂: 41%, Q₃: 30%, Q₄: 9% DB=0.56

### Example 5

### Hyperbranched Polyethoxysiloxane

345.3 g of Dynasylan® 40, 28.6 g (0.28 mol) of acetic anhydride and 0.94 g (3.2 mmol) of titanium-4 isopropoxide were weighed into a 500 ml 4-necked flask equipped with stirrer, thermometer, Vigreux column and distillation head with collection flasks, homogenized under a nitrogen atmosphere and heated until distillate passed over. The distillation was continued until at a temperature of 133° C. no more distillate passed over. Next, distillation was performed for 1.5 hrs on the rotary evaporator at 120° C. (5 mbar).

Characterization of the product by gel permeation chromatography and ²⁹Si NMR gave:

GPC: M_{w} 1540 g/mol, Mₙ 774 g/mol, P_{d} 1.98

²⁹Si NMR: Q₀: 1%, Q₁: 20%, Q₂: 44%, Q₃: 28%, Q₄: 7% DB=0.52

### Example 6

### Methoxypolyethylene Glycol-Modified Hyperbranched Polyethoxysilane

78.0 g of the substance produced in example 5 and 22.0 g (0.063 mol) of MPEG 350 were weighed into a 250 ml 4-necked flask equipped with stirrer, thermometer, (100 mm) dephlegmator and distillation head with collection flasks, homogenized under a nitrogen atmosphere and heated until distillate passed over. The distillation was continued until at a temperature of 133° C. no more distillate passed over. Next, distillation was performed for 1.5 hrs on the rotary evaporator at 120° C. (5 mbar).

Characterization of the product by gel permeation chromatography gave:

GPC: M_{w} 2170 g/mol, Mₙ 811 g/mol, P_{d} 2.67

²⁹Si NMR: Q₀: 1%, Q₁: 20%, Q₂: 44%, Q₃: 28%, Q₄: 7% DB=0.52

### Example 7

### Methoxyethoxy-Modified Hyperbranched Polyethoxysiloxane

78.0 g of the substance produced in example 5 and 22.0 g (0.289 mol) of methyl glycol were weighed into a 250 ml 4-necked flask equipped with stirrer, thermometer, (100 mm) dephlegmator and distillation head with collection flasks, homogenized under a nitrogen atmosphere and heated until distillate passed over. The distillation was continued until at a temperature of 133° C. no more distillate passed over. Next, distillation was performed for 1.5 hrs on the rotary evaporator at 120° C. (5 mbar).

Characterization of the product by gel permeation chromatography gave:

GPC: M_{w} 1684 g/mol, Mₙ 718 g/mol, P_{d} 2.34

²⁹Si NMR: Q₀: 1%, Q₁: 20%, Q₂: 44%, Q₃: 28%, Q₄: 7% DB=0.52

### Example 8

### Isononanol-Modified Hyperbranched Polyethoxysiloxane

80.0 g of the substance produced in example 5 and 20.0 g (0.138 mol) of isononanol were weighed into a 250 ml 4-necked flask equipped with stirrer, thermometer, (100 mm) dephlegmator and distillation head with collection flasks, homogenized under a nitrogen atmosphere and heated until distillate passed over. The distillation was continued until at a temperature of 133° C. no more distillate passed over. Next, distillation was performed for 1.5 hrs on the rotary evaporator at 120° C. (5 mbar).

Characterization of the product by gel permeation chromatography gave:

GPC: M_{w} 2140 g/mol, Mₙ 880 g/mol, P_{d} 2.43

²⁹Si NMR: Q₀: 1%, Q₁: 20%, Q₂: 44%, Q₃: 28%, Q₄: 7% DB=0.52

### Example 9

### Allyl Glycol-Modified Hyperbranched Polyethoxysiloxane

80.0 g of the substance produced in example 5 and 20.0 g (0.196 mol) of allyl glycol were weighed into a 250 ml 4-necked flask equipped with stirrer, thermometer, (100 mm) dephlegmator and distillation head with collection flasks, homogenized under a nitrogen atmosphere and heated until distillate passed over. The distillation was continued until at a temperature of 133° C. no more distillate passed over. Next, distillation was performed for 1.5 hrs on the rotary evaporator at 120° C. (5 mbar).

Characterization of the product by gel permeation chromatography gave:

GPC: M_{w} 2040 g/mol, Mₙ 788 g/mol, P_{d} 2.59

²⁹Si NMR: Q₀: 1%, Q₁: 20%, Q₂: 44%, Q₃: 28%, Q₄: 7% DB=0.50

### Example 10

### Polydimethylsiloxane/Isononanol-Modified Hyperbranched Polyethoxysiloxane

171.0 g of Dynasil® 40 (0.347 mol), 44.2 g (0.43 mol) of acetic anhydride and 99.5 g (0.138 mol) of an α-n-butyl-ω-trimethoxysilyl-ethyl-polydimethylsiloxane with a molecular weight of ca. 2000 g/mol (see example 1a in DE 102008031901 A1) were weighed into a 500 ml 4-necked flask equipped with stirrer, thermometer, (100 mm) dephlegmator and distillation head with collection flasks, homogenized under a nitrogen atmosphere and heated until distillate passed over. The distillation was continued until at a temperature of 133° C. no more distillate passed over. Next, distillation was performed for 1.5 hrs on the rotary evaporator at 120° C. (5 mbar).

80.0 g of this substance and 20.0 g (0.138 mol) of isononanol were weighed into a 250 ml 4-necked flask equipped with stirrer, thermometer, (100 mm) dephlegmator and distillation head with collection flasks, homogenized under a nitrogen atmosphere and heated until distillate passed over. The distillation was continued until at a temperature of 133° C. no more distillate passed over. Next, distillation was performed for 1.5 hrs on the rotary evaporator at 120° C. (5 mbar).

Characterization of the product by gel permeation chromatography gave:

GPC: M_{w} 6600 g/mol, Mₙ 1785 g/mol, P_{d} 3.7

²⁹Si NMR: Q₀: 1%, Q₁: 13%, Q₂: 40%, Q₃: 38%, Q₄: 8% DB=0.58

### Example 11

### Methoxypolyethylene Oxide-Modified Hyperbranched Polyethoxysiloxane

162.0 g (0.329 mol) of Dynasylan® 40, 44.4 g (0.082 mol) of Silquest A-1230, 28.0 g (0.274 mol) of acetic anhydride and 0.94 g (3.2 mmol) of titanium-4 isopropoxide were weighed into a 500 ml 4-necked flask equipped with stirrer, thermometer, dephlegmator and distillation head with collection flasks, homogenized under a nitrogen atmosphere and heated until distillate passed over. The distillation was continued until at a temperature of 133° C. no more distillate passed over. Next, distillation was performed for 1.5 hrs on the rotary evaporator at 120° C. (5 mbar).

Characterization of the product by gel permeation chromatography gave:

GPC: M_{w} 1974 g/mol, Mₙ 736 g/mol, P_{d} 2.68

²⁹Si NMR: Q₀: 2%, Q₁: 21%, Q₂: 45%, Q₃: 28%, Q₄: 4% DB=0.48

### Comparative Example 1

### Tetraethoxysilane

Tetraethoxysilane (=TEOS=Dynasylan® A)

Dynasylan® A is a commercial product of the company Degussa-Evonik and has a degree of crosslinking DB of 0.

### Comparative Example 2

### Polyethoxysiloxane

Dynasylan® 40

Dynasylan® 40 is a TEOS oligomer commercially available from Evonik-Degussa.

Characterization of the product by gel permeation chromatography and ²⁹Si NMR gave:

GPC: M_{w} 624 g/mol, Mₙ 376 g/mol, P_{d} 1.66

Si²⁹ NMR: Q₀: 9%, Q₁: 35%, Q₂: 37%, Q₃: 19%, Q₄: 0% DB=0.38

### Comparative Example 3

### Methoxypolyethylene Glycol-Modified Polyethoxysiloxane

78.0 g of Dynasylan® 40, 22.0 g (0.063 mol) of MPEG 350 and 0.25 g (0.879 mmol) of titanium-4 isopropoxide were weighed into a 500 ml 4-necked flask equipped with stirrer, thermometer, (70 mm) Vigreux column and distillation head with collection flasks, homogenized under an N₂ atmosphere and heated until distillate passed over. The distillation was continued until at a temperature of 133° C. no more distillate passed over. Next, distillation was performed for 1.5 hrs on the rotary evaporator at 120° C. (5 mbar).

Characterization of the product by gel permeation chromatography gave:

GPC: M_{w} 907 g/mol, Mₙ 482 g/mol, P_{d} 1.88

### Comparative Example 4

### Methoxyethoxy-Modified Polyethoxysiloxane

78.0 g of Dynasylan® 40, 22.0 g (0.289 mol) of methyl glycol and 0.25 g (0.879 mmol) of titanium-4 isopropoxide were weighed into a 250 ml 4-necked flask equipped with stirrer, thermometer, (70 mm) Vigreux column and distillation head with collection flasks, homogenized under an N₂ atmosphere and heated until distillate passed over. The distillation was continued until at a temperature of 133° C. no more distillate passed over. Next, distillation was performed for 1.5 hrs on the rotary evaporator at 120° C. (5 mbar).

Characterization of the product by gel permeation chromatography gave:

GPC: M_{w} 762 g/mol, Mₙ 451 g/mol, P_{d} 1.68

### Example 12

### Lyophilizate of the Product from Example 2 with Polystyrene

20 g of polystyrene (Mw=190000 g/mol; Aldrich) are dissolved in 300 ml dioxan in a vessel fitted with a nitrogen inlet and a stirrer. After complete dissolution of the polystyrene, 80 g of the product from example 2 are added. The mixture is stirred for a further 10 mins. The vessel is then shock frozen in liquid nitrogen and attached to a freeze-drying apparatus (Scanvac Coolsafe) for 18 hrs in order to remove the dioxan completely. An almost white powder is obtained, which contains 80 wt. % of the additive from example 2 mixed with polystyrene.

### Example 13

### Oil-in-Oil Microencapsulation of the Product from Example 1 with PEMA

3.36 g of the encapsulation polymer PEMA (poly(ethyl methacrylate), Mw=50000; Polysciences Inc.) and 6.53 g of the product from example 1 were dissolved in a solvent mixture of acetonitrile (10 ml) and methylene chloride (40 ml). This solution is added dropwise with stirring (500 rpm) to the continuous phase of 10 ml paraffin oil (from J. T. Baker) which contains as emulsifier 0.1 ml of sorbitan monooleate (Span80, Merck AG). After addition of the whole solution, stirring is continued at a rate of 500 rpm for 16 hrs. In order to separate the micro-capsules from the continuous paraffin oil phase, the stirring is stopped, so that the microcapsules can settle out. The oil is decanted and the microcapsules are washed several times with pentane. Next the microcapsules are filtered off and dried in air. Analysis by ¹H NMR gave a content of the microcapsules with the product from example 1 of ca. 50±2 wt. %.

### Example 14

### Oil-in-Water Microencapsulation of the Product from Example 1 with PEMA

12.96 g of the encapsulation polymer PEMA (poly(ethyl methacrylate), Mw=50000; Polysciences Inc.) were dissolved in 100 ml ethyl acetate. After complete dissolution, 11.90 g of the product from example 1 were added. As the disperse phase, 1000 ml of an 0.5 wt. % aqueous polyvinyl acetate solution are prepared (polyvinyl acetate: Mw=9000-10000 g/mol, 80% hydrolyzed; Aldrich). The solution of PEMA and the product from example 1 is added dropwise with stirring (500 rpm) to the disperse polyvinyl acetate-containing phase. After addition of the whole solution, stirring is continued at a rate of 500 rpm overnight. In order to separate the microcapsules from the continuous aqueous phase, the stirring is stopped, so that the microcapsules can settle out. The aqueous layer is decanted and the microcapsules are washed with water. Next the micro-capsules are suspended in water and freeze-dried. Analysis by ¹H NMR gave a content of the microcapsules with the product from example 1 of ca. 45 wt. %.

### Example 15

### Polydimethylsiloxane-Modified Hyperbranched Polyethoxysiloxane

442.0 g of Dynasilan® 40, 76.3 g of acetic anhydride (0.75 mol) and 81.6 g (0.027 mol) of an alpha-n-butyl-omega-triethoxysilyl-ethyl-polydimethylsiloxane with a molecular weight of ca. 3000 g/ml (synthesized in the same manner as described in DE 102008031901 A1), and 1.5 g (5.1 mmol) of titanium-4 isopropoxide were weighed into a 1000 ml 4-necked flask equipped with stirrer, thermometer, (100 mm) dephlegmator and distillation head with collection flasks, homogenized under a nitrogen atmosphere and heated until distillate passed over. The distillation was continued until at a temperature of 133° C. no more distillate passed over. Next, distillation was performed for 1.5 hrs on the rotary evaporator at 120° C. (5 mbar).

Characterization of the product by gel permeation chromatography gave:

GPC: M_{w} 3587 g/mol, Mₙ 964 g/mol, P_{d} 3.7

²⁹Si NMR: Q₀: 2%, Q₁: 19%, Q₂: 42%, Q₃: 32%, Q₄: 5% DB=0.54

### Example 16

### Polydimethylsiloxane-Modified Hyperbranched Polyethoxysiloxane

218.0 g of Dynasil® 40, 44.2 g of acetic anhydride (0.43 mol) and 44.3 g (0.037 mol) of an alpha-n-butyl-omega-triethoxysilyl-ethyl-polydimethylsiloxane with a molecular weight of ca. 1200 g/ml (synthesized in the same manner as described in DE 102008031901 A1), and 0.76 g (2.6 mmol) of titanium-4 isopropoxide were weighed into a 500 ml 4-necked flask equipped with stirrer, thermometer, (100 mm) dephlegmator and distillation head with collection flasks, homogenized under a nitrogen atmosphere and heated until distillate passed over. The distillation was continued until at a temperature of 133° C. no more distillate passed over. Next, distillation was performed for 1.5 hrs on the rotary evaporator at 120° C. (5 mbar).

Characterization of the product by gel permeation chromatography gave:

GPC: M_{w} 3635 g/mol, Mₙ 1175 g/mol, P_{d} 3.1

²⁹Si NMR: Q₀: 1%, Q₁: 16%, Q₂: 42%, Q₃: 34%, Q₄: 7% DB=0.57

### Example 17

### Polyethylene Glycol Block Polydimethyl-Siloxane-Modified Hyperbranched Polyethoxysiloxane

Synthesis of polyethylene glycol block polydimethyl-siloxane:

Monoallyl polyethylene glycol (147 g, Mn=480 g/mol) and Karstedt catalyst (4 g, 0.2% solution in xylene) are placed beforehand in a four-necked flask equipped with stirrer, thermometer, dropping funnel, reflux condenser and nitrogen inlet tube and heated to 60° C. The metered addition of a mono-SiH functional polydimethylsiloxane (500 g, Mn≈2000 g/mol) is effected in such a manner that the temperature does not exceed 70° C. The conversion of the mono-SiH functional polysiloxanes is followed by means of gas volumetric determination. The measured hydroxy number of the product is 28.1 mg KOH/g.

Synthesis of polyethylene glycol block polydimethyl-siloxane-modified hyperbranched polyethoxysiloxane:

160.0 g of a substance produced according to example 5 and 40.0 g (0.016 mol) of polyethylene glycol block polydimethylsiloxane were weighed into a 250 ml 4-necked flask equipped with stirrer, thermometer and distillation head with collection flasks, homogenized under a nitrogen atmosphere and heated until distillate passed over. The distillation was continued until at a temperature of 133° C. no more distillate passed over. Next, distillation was performed for 1.5 hrs on the rotary evaporator at 120° C. (5 mbar).

Characterization of the product by gel permeation chromatography gave:

GPC: M_{w} 3806 g/mol, Mₙ 956 g/mol, P_{d} 3.98

²⁹Si NMR: Q₀: 2%, Q₁: 19%, Q₂: 40%, Q₃: 32%, Q₄: 7% DB=0.55

Comparison of the Nonhydrolytic Method According to the Disclosure with a Hydrolytic Method According to (EP 0771 835 A2)

### Example H1 (Comparative Example)

### Polymethoxysiloxane-Hydrolytic Method

228 g (1.5 mol) of tetramethoxysilane and 72 g (2.25 mol) methanol were weighed into a 500 ml 4-necked flask equipped with stirrer, thermometer and reflux condenser and stirred for 5 minutes under a nitrogen atmosphere. Next a mixture of 29.7 g (1.65 mol) water and 0.055 g of 20% HCl was added, and heated to reflux. Allow to react for 4 hrs at the reflux temperature of 65° C. which is established. After cooling to room temperature and exchange of the reflux condenser for a distillation head with collection flasks, methanol present was removed by distillation at a temperature of 65° C.-150° C. Volatile substances remaining in the product were removed within 2 hours at a temperature of 150° C. by passing in nitrogen (purity>99.999%).

GPC: M_{w} 1730 g/mol, Mₙ 780 g/mol, P_{d} 2.2

²⁹Si NMR: Q₀: 0.5%, Q₁: 13.5%, Q₂: 55%, Q₃: 28%, Q₄: 3% DB=0.55

### Example NH2

### Polyethoxysiloxane-Nonhydrolytic Method According to the Disclosure

250.0 g (1.2 mol) of tetraethoxysilane, 134.8 g (1.32 mol) of acetic anhydride and 0.96 g (3.4 mmol) of titanium-4 isopropoxide were weighed into a 500 ml 4-necked flask equipped with stirrer, thermometer, Vigreux column and distillation head with collection flasks, homogenized under a nitrogen atmosphere and heated until distillate passed over. The distillation was continued until at a temperature of 133° C. no more distillate passed over. Next, distillation was performed for 1.5 hrs on the rotary evaporator at 120° C. (5 mbar).

GPC: M_{w} 2104 g/mol, Mₙ 731 g/mol, P_{d} 2.9

²⁹Si NMR: Q₀: 3%, Q₁: 20%, Q₂: 42%, Q₃: 30%, Q₄: 5% DB=0.54

### Example H2 (Comparative Example)

### Polyethoxysiloxane-Hydrolytic Method

270.8 g (1.3 mol) of tetraethoxysilane and 89.7 g (1.95 mol) ethanol were weighed into a 500 ml 4-necked flask equipped with stirrer, thermometer and reflux condenser and stirred for 5 minutes under a nitrogen atmosphere. Next a mixture of 25.7 g (1.43 mol) water and 0.047 g of 20% HCl was added, and heated to reflux. Allow to react for 4 hrs at the reflux temperature of 78° C. which is established. After cooling to room temperature and exchange of the reflux condenser for a distillation head with collection flasks, ethanol present was removed by distillation at a temperature of 78° C.-150° C. Volatile substances remaining in the product were removed within 2 hours at a temperature of 150° C. by passing in nitrogen (purity>99.999%).

GPC: M_{w} 1207 g/mol, Mₙ 549 g/mol, P_{d} 2.2

²⁹Si NMR: Q₀: 0%, Q₁: 14%, Q₂: 55%, Q₃: 27%, Q₄: 4% DB=0.55

### Application Technology Examples

Coating Agents Based on a Heat-Curing Polyester/Melamine Resin System

In accordance with the following table 1, a solvent-based high gloss polyester/melamine stoving enamel (formulation 1) and a solvent-based matt polyester/melamine stoving enamel (formulation 2) were produced.

TABLE 1

| | | |
|---|---|---|
| Constituents | Formulation 1 | Formulation 2 |

| | | | | |
|---|---|---|---|---|
| Mill base | | | | |
| Uralac SN 804^{a} | 24.8 | g | 24.8 | g |
| Disperbyk 110^{b} | 0.9 | g | 0.9 | g |
| Solvesso 150 ND^{c} | 3.5 | g | 3.5 | g |
| Aerosil R972^{d} | 0.3 | g | 0.3 | g |
| Ti-pure R 960^{e} | 29.6 | g | 29.6 | g |
| Let-down | | | | |
| Uralac SN 804^{a} | 23.6 | g | 23.6 | g |
| Cymel 303^{f} | 7.9 | g | 7.9 | g |
| Dynapol Catalyst 1203^{g} | 3.9 | g | 3.9 | g |
| Byk-057^{h} | 0.3 | g | 0.3 | g |
| Butyl diglycol | 2.2 | g | 2.2 | g |
| Solvesso 150 ND^{c} | 3.0 | g | 2.0 | g |

| | | | |
|---|---|---|---|
| Byk 350ⁱ, 50% in | — | 1.0 | g |
| Solvesso 150 ND^{c} | | | |

^{a}Polyester binder, DSM, 65% in Solvesso 150 ND
^{b}Wetting agent and dispersant, Byk
^{c}Solvent, ExxonMobil
^{d}Pyrogenic silicic acid, Degussa
^{e}Titanium dioxide, DuPont
^{f}Hexamethoxymethylmelamine, Cytec, 100%
^{g}Blocked sulfonic acid derivative, Evonik
^{h}Defoamant, Byk
ⁱLevelling agent, Byk

The mill base was dispersed by means of a Dispermat CV for 20 minutes at 8000 rpm and 40° C. The weight ratio of the mill base to the glass beads was 1:1.

The mill base and the let-down were mixed and homogenized for 5 mins.

In addition, formulation 2 was matted with 2% Syloid ED 30 (silicic acid matting agent, Grace) (5 mins, 930 rpm).

The viscosity of each of the two formulations was adjusted to 100 to 120 secs (measured with a DIN 4 cup) with Solvesso 150ND.

Subsequently, 1 wt. % or 2 wt. % of the additives from the production examples were incorporated into the formulation 1 and the formulation 2, firstly by stirring with a spatula, then with a dissolver for 3 minutes at 1865 rpm with a toothed disk. The percentage weight data correspond to the quantity of the additive in grams (without any carrier substances or solvents) based on 100 grams of the formulation 1 or formulation 2. The quantities of additives can be obtained from the results tables.

After storage overnight at room temperature, the samples are applied with a spiral applicator in a wet film thickness of 80 μm (corresponds to a dry film thickness of 19-20 μm) onto an Alcan aluminum plate coated with a primer. The coated plates were stoved for 33 seconds in an oven (oven temperature: 320° C.) with a peak metal temperature (PMT) of 232° C.

Test Methods

1. Determination of the Hydrophilicity of the Stoved Formulations by Measurement of the Water Contact Angle

The contact angle measurements were performed 24 hours after storage at room temperature and after 24 hours, 7 days or 21 days storage in water (Measuring instrument: Krüss G2).

2. Soiling Tests on the Stoved Formulations

(a) Carbon Black Test (“CB Test”)

The carbon black test was performed 21 days after storage at room temperature and 21 days after storage in water.

The coated plates were dipped 5 times in the pigment Special Black 4. Then wetted at angle of 45° with water and stored 1 hour at 100° C. Next, the pigment is washed off with water and a soft cloth, so that the loose pigment can be removed. The residues remaining are assessed (1=no residues, 10=major residues).

(b) Carbon Black Slurry Test (“CB Slurry Test”)

The carbon black slurry test was performed 21 days after storage at room temperature and 21 days after storage in water.

The slurry was applied onto the enamel surface with a brush and the plates were stored 1 hour at 100° C. Next, the pigment was washed off with water and a soft cloth, so that the loose pigment can be removed. The residues remaining are assessed (1=no residues, 10=major residues). The carbon black FW 200 slurry had the following composition: 57.6 g water, 26.3 g DISPERBYK®-190 (40%) from BYK-Chemie GmbH, 1.0 g BYK-024 from Byk-Chemie GmbH, 0.1 g Acticide MBS (a biocide from Thor Chemie) and 15.0 g coloring carbon black FW 200 (obtainable from Evonik Industries). The aforesaid components were milled with a Dispermat CV (Teflon blades, 60 minutes, 10000 rpm (18 m/sec), 40° C.). The weight ratio of the mill base to the glass beads (Ø1 mm) was 1:1.

3. Determination of Gloss and Haze of the Stoved Formulations

The gloss and haze measurement was performed with the Micro-Haze-Gloss instrument from BYK-Gardner. The gloss was measured at an angle of 20°.

4. Assessment of the Surface of the Stoved Formulations

The surface was visually assessed for defects and appearance. (1=no defects, 5=defects, C=craters)

5. Measurement of the Leveling of the Stoved Formulations

The leveling was measured on the coated plates with the Wave-Scan-Dual instrument from BYK-Gardner. The long wave (LW) and the short wave (SW) were determined.

Results

Table 2 lists the measurement results for the coatings which were produced from formulation 1 (enamel 1)—as described above.

TABLE 2

| | | | | | | Storage at | | Storage | |
|---|---|---|---|---|---|---|---|---|---|
| Enamel | Wt. % | | | | | 25° C. | | in water | |
| 1 + | additive | | | Surface | | Contact angle | | Contact angle | |
| additive | (active | Gloss | | Lev. | Lev. | 1 | 42 | 1 | 7 |
| from | subst.) | 20° | Haze | LW | SW | day | days | day | days |

| | | | | | | | | |
|---|---|---|---|---|---|---|---|---|
| Ex. 1 | 2 | 80 | 6 | 1 | 92 | 86 | 35 | 35 |

| | |
|---|---|
| 2.9 | 40.9 |

| | | | | | | | | |
|---|---|---|---|---|---|---|---|---|
| Ex. 4 | 2 | 80 | 5 | 1 | 84 | 85 | 54 | 33 |

| | |
|---|---|
| 2.4 | 37.0 |

| | | | | | | | | |
|---|---|---|---|---|---|---|---|---|
| Ex. 5 | 2 | 76 | 5 | 1 | 89 | 86 | 50 | 40 |

| | |
|---|---|
| 2.5 | 35.9 |

| | | | | | | | | |
|---|---|---|---|---|---|---|---|---|
| Ex. 7 | 2 | 77 | 5 | 1 | 85 | 77 | 38 | 38 |

| | |
|---|---|
| 3.1 | 41.8 |

| | | | | | | | | |
|---|---|---|---|---|---|---|---|---|
| Comp. | 2 | 36 | 14 | 5 C. | 89 | 89 | 84 | 83 |
| Ex. 1 | | | | | | | | |

| | |
|---|---|
| 36.2 | 36.8 |

| | | | | | | | | |
|---|---|---|---|---|---|---|---|---|
| Control | 0 | 33 | 18 | 5 C. | 89 | 88 | 85 | 83 |

| | |
|---|---|
| 37.5 | 44.9 |

| | | | | | | | | |
|---|---|---|---|---|---|---|---|---|
| ZEFFLE | 2 | 47 | 11 | 3 matt | 76 | 50 | 25 | 30 |
| GH-701* | | | | | | | | |

| | |
|---|---|
| 7.4 | 42.6 |

*ZEFFLE GH-701 is a fluoro-organosilicate-based hydrophilization additive from DAIKIN INDUSTRIES LTD. which imparts soiling resistance to coating agents.

As is clear from table 2, use according to the disclosure of the hyperbranched polyalkoxysiloxane additives leads to improved gloss, decreased gloss misting (haze), and markedly improved leveling properties, in particular in the long wave range and this without use of fluorine-containing or polyacrylate-based leveling agents. The water contact angles after 7 day storage under water show that marked hydrophilization of the surface has occurred, which is attributable to the formation of a silicic acid network on the coating surface.

Table 3 lists the measurement results for the coatings which were produced from formulation 2 (enamel 2)—as described above.

TABLE 3

| | | | | Measurement | | | |
|---|---|---|---|---|---|---|---|
| | | | | after | | | |
| | | Immediate | | 24 hour storage | | Contact angle | |
| Enamel | Wt. % | measurement | | under water | | | after 24 |
| 2 + | additive | | CB | | CB | | hrs |
| additive | (active | CB | slurry | CB | slurry | imme- | under |
| from | substance) | test | test | test | test | diate | water |
| Ex. 3 | 1 | 1 | 3 | 0.5 | 1.5 | 82 | 55 |
| Ex. 3 | 2 | 1 | 3 | 0.5 | 0.5 | 88 | 45 |
| Ex. 7 | 1 | 3.5 | 4 | 0.5 | 1.5 | 89 | 36 |
| Comp. | 1 | 7.5 | 7 | 7 | 7 | 93 | 90 |
| Ex. 1 | | | | | | | |
| Comp. | 2 | 4.5 | 5 | 6 | 7 | 93 | 91 |
| Ex. 1 | | | | | | | |
| Comp. | 1 | 6 | 5 | 2.5 | 4.5 | 87 | 81 |
| Ex. 2 | | | | | | | |
| Comp. | 2 | 4.5 | 5 | 1.5 | 4.5 | 86 | 73 |
| Ex. 2 | | | | | | | |
| Comp. | 1 | 6 | 4 | 5.5 | 4.5 | 85 | 88 |
| Ex. 4 | | | | | | | |
| Comp. | 2 | 6 | 4 | 2 | 4.5 | 78 | 70 |
| Ex. 4 | | | | | | | |
| Control | 0 | 6 | 6 | 6 | 7 | 79 | 87 |
| ZEFFLE | 1 | 5 | 7.5 | 4 | 8.5 | 88 | 88 |
| GH-701 | | | | | | | |
| ZEFFLE | 2 | 4 | 7 | 3.5 | 8.5 | 89 | 85 |
| GH-701 | | | | | | | |

From the results in table 3, it can be seen that the addition of the hyperbranched polyalkoxysiloxane greatly improves the self-cleaning properties of the coating agent composition. Both in the CB test and also in the CB slurry test, the surfaces were easy to clean by water rinsing. The self-cleaning properties are not adversely influenced even in the presence of a leveling agent of the polyacrylate type (BYK 350) in formulation 2 (enamel 2). Leveling agents of the polyacrylate type, on account of their low glass transition temperature, are known to make surfaces somewhat more susceptible to adhering dirt.

Production of Powder Enamel Formulations

TABLE 4

| | | Powder enamel | |
|---|---|---|---|
| Constituent | | control | Powder enamel |
| No. | Constituent | formulation | formulation |
| | Binder/crosslinker | | |
| 1 | Crylcoat 2617-3^{j} | 43.3 | 43.3 |
| 2 | Primid XL 552^{k} | 3.3 | 3.3 |
| | Pigment | | |
| 3 | Kronos 2160^{l} | 33.2 | 33.2 |
| | Additives | | |
| 4 | Benzoin | 0.4 | 0.4 |
| 5 | BYK 3902 P^{m} | 0.8 | 0.8 |
| 6 | Crylcoat 2617-3 | 19.0 | 0 |
| | “milled”ⁿ | | |
| 7 | Masterbatch, 5%^{o} | 0 | 20.0 |
| | | 100.0 | 101.0 |

^{j}Polyester resin from Cytec
^{k}Hydroxyalkylamide crosslinker from EMS-Chemie
^{l}Titanium dioxide from Kronos
^{m}Levelling agent from BYK-Chemie GmbH
ⁿCrylcoat 2617-3 was milled to about the particle size of the masterbatch with a high speed mixer
^{o}The additives were incorporated as 5 wt. % masterbatch in Crylcoat 2617-3 by melting the Crylcoat 2617-3 and admixture of the additive. This was taken into account in weighing out the resin. After cooling, the masterbatch mixture is milled.

All components of constituent numbers 1 to 5 in table 4 were weighed out together and premixed for 2.5 minutes at 1500 rpm in a high speed mixer. The components of constituent numbers 6 and 7 were added and mixed in manually.

Next, the mixtures were extruded at 100° C. in a double screw extruder of the Coperion ZSK 18 type (shaft speed 350 rpm). The resulting extrudate was cooled, broken up and milled at 18000 rpm in a Retsch ZM 100 centrifugal mill. The resulting powder was passed through a 100 μm vibrating screen (DIN 4188). The resulting powder enamel mixtures were then applied electrostatically onto Q Panels aluminum A-36 plates (152×76×0.5 mm) (powder spray pistol: 80 kV/1.0 bar) and the plates thus coated were cured for 15 minutes at 180° C. in the fan oven.

Test Methods

The brightness L* was measured with a BYK-Gardner Spectro-guide Sphere Gloss color and gloss meter.

Results

The brightness value L* of the plates enameled with the powder enamel formulations was tested one or three weeks after storage. The results are shown in table 5.

TABLE 5

| | | Layer | | |
|---|---|---|---|---|
| Powder enamel + | Wt. % | thickness | L* | L* |
| additive from | additive | μm | 1 week | 3 weeks |
| Ex. 2 | 1.00 | 75-80 | 95.60 | 96.37 |
| Ex. 12 | 1.25^{#} | 75-80 | 95.84 | 96.42 |
| Comp. Ex. 1 | 1.00 | 75-80 | 96.42 | 96.44 |
| Comp. Ex. 2 | 1.00 | 75.80 | 96.21 | 96.52 |
| No additive | 0.00 | 75-80 | 96.31 | 96.82 |

^{#}In order to apply the same quantity of active substance as in the other examples, a higher weight content of the additive from example 12 was used, since this as well as polystyrene only contains 80% of additive from example 2.

Soiling Test on the Stoved Powder Enamel Coatings

A carbon black slurry is produced by mixing 20 g of Carbon Special Black #4 pigment with 65 g deionized water. About one teaspoon of the slurry is spread onto each coated plate. The test plates were stored in an oven at 70° C. for 2 hours. Next under flowing cold deionized water the plates were rinsed clean with a bristle brush by gentle wiping without scratching. Next the plates were dried at room temperature and the brightness values L* determined—as stated above.

TABLE 6

| | | Layer | | |
|---|---|---|---|---|
| Powder enamel + | Wt. % | thickness | L* | L* |
| additive from | additive | μm | 1 week | 3 weeks |
| Ex. 2 | 1.00 | 75-80 | 83.82 | 91.78 |
| Ex. 12 | 1.25^{#} | 75-80 | 85.54 | 90.68 |
| Comp. Ex. 1 | 1.00 | 75-80 | 45.61 | 60.24 |
| Comp. Ex. 2 | 1.00 | 75.80 | 74.03 | 87.15 |
| No additive | 0.00 | 75-80 | 48.59 | 55.14 |

^{#}In order to apply the same quantity of active substance as in the other examples, a higher weight content of the additive from example 12 was used, since this as well as polystyrene only contains 80% of additive from example 2.

Table 6 shows that with use of the additive according to the disclosure from example 2 as pure active substance or the 80 wt. % active substance in polystyrene, better results are obtained as regards the strong dirt-repelling action.

Coating Agents Based on Fluoropolymers

In accordance with the following table 7, two different coating agent formulations formulation F1 and formulation F2 were produced.

TABLE 7

| | | |
|---|---|---|
| Constituents | Formulation F1 | Formulation F2 |

Master enamel

| | | | |
|---|---|---|---|
| Lumiflon LF-200^{p} | 57.2 | g | — |

| | | | |
|---|---|---|---|
| GK-570^{q} | — | 57.2 | g |

| | | | | |
|---|---|---|---|---|
| Ti-Pure R960^{r} | 20.0 | g | 20.0 | g |

| | | | |
|---|---|---|---|
| Xylene | 11.3 | g | — |

| | | | |
|---|---|---|---|
| Butyl acetate | — | 11.3 | g |

| | | | | |
|---|---|---|---|---|
| Disperbyk-2025^{s} | 0.6 | g | 0.6 | g |
| Blanc fixe micro^{t} | 10.0 | g | 10.0 | g |
| BYK-320^{u} | 0.1 | g | 0.1 | g |
| BYK-085^{v} | 0.3 | g | 0.3 | g |
| Crosslinkers | | | | |
| Desmodur N3300^{w} | 6.1 | g | 9.1 | g |

^{p}3F type fluorocarbon-based binder from Asahi Glass
^{q}4F type fluorocarbon-based binder from Daikin Industries
^{r}Titanium dioxide from DuPont
^{s}Crosslinker and dispersant from BYK-Chemie GmbH
^{t}Barium sulfate from Sachtleben Chemie GmbH
^{u}Silicone-based surface additive from BYK-Chemie GmbH
^{v}Silicone-based defoamant from BYK-Chemie GmbH
^{w}Hexamethylene diisocyanate trimer (90%) from Bayer AG

Next, 2 wt. % of the additive, based on the fluorine-containing binder, were admixed (2000 rpm, 5 minutes). The finished coating agents containing the additive were each applied onto glass plates in wet film thicknesses of 200 μm. The glass plates were stored for 3 days at room temperature. Next, the test methods described below were performed.

Test Methods for Fluoropolymer-Based Formulations

1. Determination of the Hydrophilicity of the Fluorine-Containing Formulations by Measurement of the Water Contact Angle

The contact angle measurements towards water were performed after the above-described three-day storage at room temperature and after subsequent 7-day storage in water (Measuring instrument: Krüss G2, Easy Drop).

2. Soiling Tests on the Fluorine-Containing Formulations

(a) Carbon Black Mineral Oil Test (“CB Oil Test”)

A 1 weight percent slurry of Carbon Black powder (type FW 200 from Evonik Degussa) in mineral oil (Q8 Puccini 32P from Kuwait Petroleum International Lubricants) is prepared. This is rubbed onto the coated plates with the finger. The soiled plates are stored overnight at room temperature and then cleaned with dry paper (Tork paper handkerchiefs from Svenska Cellulosa AB) or wet paper, which had been impregnated with a 5% Pril® solution, in order to test the cleanability.

(b) Carbon Black Hand Cream Test (“CB Cream Test”)

A 1 weight percent preparation of Carbon Black powder (type FW 200 from Evonik Degussa) in a hand cream (Wuta Kamille hand cream from Herbacin Cosmetic GmbH) is produced. This is rubbed onto the coated plates with the finger. The soiled plates are stored overnight at room temperature and then cleaned with dry paper (Tork paper handkerchiefs from Svenska Cellulosa AB) or wet paper (soap) which had been impregnated with a 5% Pril® solution, in order to test the cleanability.

(c) Carbon Black Slurry Test (“CB Slurry Test”)

A carbon black slurry is prepared by mixing 2.0 g of

Special Black 6 (Evonik), 100 g water and 5 drops of liquid soap (Pril®). The carbon black slurry is applied onto the coated plate with a small brush. Next, the plates are dried for 1 hour at 50° C. Then the plates are washed under running water and using a soft brush. Washing is continued without use of soap or harder scrubbing, until the coating is cleaned as well as possible.

3. Determination of Gloss and Haze of the Stoved Formulations

The gloss and haze measurement was performed with the Micro-Haze-Gloss instrument from BYK-Gardner. The gloss was measured at an angle of 60°.

Results

TABLE 8
Formulation F1 (after three-day drying)

| | | | Water | | | | | |
|---|---|---|---|---|---|---|---|---|
| | | | contact | CB | | CB | | CB |
| Addi- | Gloss | Haze | angle | oil test | | cream test | | slurry |
| tive | (60°) | (60°) | (°) | cloth | soap | cloth | soap | test |
| Ex. 1 | 74.9 | 52.2 | 96 | 2.5 | 1 | 1.5 | 1 | 3.5 |
| Ex. 3 | 72.5 | 40.7 | 90 | 2 | 1 | 1.5 | 1.5 | 2 |
| Comp. | 72.6 | 19.2 | 105 | 2.5 | 1 | 2 | 2 | 4.5 |
| Ex. 1 | | | | | | | | |
| Comp. | 72.0 | 23.3 | 102 | 2 | 1 | 2.5 | 1 | 4.5 |
| Ex. 2 | | | | | | | | |
| Control | 71.8 | 24.9 | 103 | 3 | 1 | 3 | 3.5 | 4.5 |
| ZEFFLE | 78.7 | 20 | 88 | 2.5 | 1 | 1.5 | 1 | 2 |
| GH-701 | | | | | | | | |

TABLE 9
Formulation F1 (after three-day drying
and then 7 day storage under water)

| | Water | | | | | |
|---|---|---|---|---|---|---|
| | contact | CB | | CB | | CB |
| Addi- | angle | oil test | | cream test | | slurry |
| tive | (°) | cloth | soap | cloth | soap | test |
| Ex. 1 | 67 | 2.5 | 1 | 2 | 1 | 2 |
| Ex. 3 | 47 | 2 | 1 | 2 | 1.5 | 2 |
| Comp. | 90 | 2.5 | 1 | 2 | 1 | 4.5 |
| Ex. 1 | | | | | | |
| Comp. | 88 | 2 | 1 | 2 | 1 | 3.5 |
| Ex. 2 | | | | | | |
| Control | 92 | 3 | 1 | 2 | 1 | 4 |
| ZEFFLE | 52 | 2.5 | 1 | 2 | 1 | 2.5 |
| GH-701 | | | | | | |

TABLE 10
Formulation F2 (after three-day drying)

| | | | | Water | | | | | |
|---|---|---|---|---|---|---|---|---|---|
| | | | | contact | CB | | CB | | CB |
| Addi- | | Gloss | Haze | angle | oil test | | cream test | | slurry |
| tive | Slip | (60°) | (60°) | (°) | cloth | soap | cloth | soap | test |
| Ex. 1 | 0.46 | 79.6 | 32.5 | 94 | 1.5 | 1 | 1 | 1 | 4 |
| Ex. 3 | 0.57 | 79.3 | 26.8 | 90 | 1 | 1.5 | 1 | 1 | 1 |
| Comp. | 0.32 | 80 | 26.1 | 102 | 2 | 1 | 2 | 1 | 4.5 |
| Ex. 1 | | | | | | | | | |
| Comp. | 0.68 | 80.4 | 16.4 | 90 | 2.5 | 1 | 1.5 | 1 | 4 |
| Ex. 2 | | | | | | | | | |
| Control | 0.36 | 80.2 | 31.1 | 101 | 3.5 | 1 | 2.5 | 1 | 4.5 |
| ZEFFLE | 0.76 | 80.5 | 21.5 | 90 | 2 | 1 | 2 | 1 | 1.5 |
| GH-701 | | | | | | | | | |

TABLE 11
Formulation F2 (after three-day drying
and then 7 day storage under water)

| | Water | | | | | |
|---|---|---|---|---|---|---|
| | contact | CB | | CB | | CB |
| Addi- | angle | oil test | | cream test | | slurry |
| tive | (°) | cloth | soap | cloth | soap | test |
| Ex. 1 | 63 | 1.5 | 1 | 1 | 1 | 2.5 |
| Ex. 3 | 66 | 1.5 | 1 | 1.5 | 1 | 2 |
| Comp. | 94 | 2 | 1 | 2 | 1 | 3.5 |
| Ex. 1 | | | | | | |
| Comp. | 89 | 2.5 | 1 | 1.5 | 1 | 3.5 |
| Ex. 2 | | | | | | |
| Control | 94 | 3.5 | 1 | 2.5 | 1 | 3.5 |
| ZEFFLE | 89 | 2 | 1 | 2 | 1 | 3.5 |
| GH-701 | | | | | | |

As can be seen from the above tables, the additives of examples 1 and 3 are advantageous as regards cleanability and water contact angle after simulated weathering (storage under water).

Coating Materials Based on a Solvent-Based Pigmented Epoxy Resin/Amine Curing Agent System

For the preparation of the coating agent, the following procedure is used. Firstly, a component A is prepared by mixing the materials listed at positions 1 to 3 of table 12 until homogeneity by means of a dissolver with a toothed disk at 2000 revolutions per minute. The relevant quantities are stated in parts by weight in table 3. Next the material of position 4 in table 12 is added and mixed at 3000 revolutions per minute until a perfect gel forms. After this, the materials of positions 5 to 7 of table 12 are added at 3000 revolutions per minute and stirring continued a further 15 minutes. After this, the materials of positions 8 to 11 of table 12 are added at 2000 revolutions per minute and stirring continued a further 5 minutes. Component B is prepared by stirring the materials of positions 12 to 14 of table 12 for 15 minutes at 2000 revolutions per minute.

In the next step, 2 wt. % of additive based on the sum of the components A and B is added to the mixtures of the components A and B and stirring performed for 5 minutes at 2000 revolutions per minute.

The coating agent composition is applied onto a glass plate in a wet film thickness of 150 μm. The glass plate kept overnight at room temperature (23° C.) and then dried in an oven at 40° C. for 3 days.

After cooling, the coating film is subjected to the test methods described below.

TABLE 12

| Position | |
|---|---|
| | Component A |

| | | |
|---|---|---|
| 1 | Dowanol PM¹ | 3.9 |
| 2 | Xylene | 4.7 |
| 3 | Epikote 1001X75² | 15.6 |
| 4 | Bentone SD-2³ | 1.2 |
| 5 | Disperbyk-142⁴ | 0.6 |
| 6 | Ti-Pure R902⁵ | 25.0 |
| 7 | Blanc Fixe N⁶ | 14.6 |
| 8 | Epikote 1001X75² | 23.4 |
| 9 | Solvesso 100⁷ | 5.9 |
| 10 | Dowanol PM¹ | 2.4 |
| 11 | Xylene | 2.7 |
| | Total | 100.0 |

Component B

| | | |
|---|---|---|
| 12 | Ancamide 220-X-70⁸ | 10.00 (95.5% |
| | | crosslinker) |
| 13 | Ancamine K-54⁹ | 0.4 |
| 14 | Xylene | 2.0 |
| | Total | 12.4 |

¹Dowanol PM is a propylene glycol methyl ether from Dow Chemical Company
²Epikote 1001X75 is a 75 wt. % solution of an epoxy resin in xylene from Momentive
³Bentone SD-2 is a rheology additive based on an organically modified bentonite clay from Elementis Specialties
⁴Disperbyk-142 is a crosslinker and dispersant from Byk Chemie GmbH
⁵Ti-Pure R902 is a titanium dioxide pigment from DuPont Titanium Technologies
⁶Blanc Fixe N is a synthetic barium sulfate from Solvay Chemicals
⁷Solvesso 100 is an aromatic solvent from ExxonMobil
⁸Ancamide 220-X-70 is a curing agent from Air Products
⁹Ancamine K-54 is an epoxy accelerator from Air Products

Test Methods

Test for Soilability

The carbon black hand cream test (“CB cream test”) and the carbon black slurry test (“CB slurry test”) were performed as stated under the above heading of the fluoropolymer-based formulations. However, no double determinations were performed. The assessment range extends from 1 to 5, where the value 1 means “no residues”, while the value 5 means “major residues”.

Marker Test

The enamel surface is written on with a permanent marker of the “Magic Ink Red” type (obtainable from Magic Ink Company, Japan) and visually assessed as to whether the surface can be written on. It is assessed whether the ink spreads on the surface or draws together. After drying of the ink, it is attempted to wipe this off with a dry cloth or with isopropanol-impregnated paper. The assessment range extends from 1 to 5, where the value 1 means “the ink draws together and can be removed with no residue with a paper cloth” and the value 5 means “the ink spreads very well on the substrate and cannot practically be removed”.

Determination of the Hydrophilicity/Hydrophobicity of the Stoved Formulations by Measurement of the Water Contact Angle

The contact angle measurements were performed 24 hours after storage at room temperature (23° C.) (measuring instrument: Krüss G2).

Results

TABLE 13

| | Water | | | | | | | | | | |
|---|---|---|---|---|---|---|---|---|---|---|---|
| | contact | | | CB | | | | | | | |
| Addi- | angle | CB | | cream test | | | | Marker test | | | |
| tive | (°) | slurry test | | Soap | | Cloth | | Isopropanol | | Cloth | |
| Control | 90 | 4 | 4 | 1 | 1 | 4 | 3 | 1 | 1 | 5 | 5 |
| Ex. 10 | 100 | 5 | 5 | 1 | 1 | 1 | 1 | 1 | 1 | 1 | 1 |
| Ex. 11 | 75 | 1 | 1 | 1 | 1 | 1 | 1 | 1 | 1 | 5 | 5 |

The results in table 13 show that the polysiloxane/isononanol-modified polyalkoxysiloxane of example 10 hydrophobizes the enamel surface and endows it with “easy-to-clean” properties (easy cleaning properties) in the marker test. The polyethylene-modified polyalkoxy-siloxane of example 11 hydrophilizes the enamel surface and endows the enamel with soiling resistance towards carbon black in the CB slurry test. Depending on the nature of the dirts typically to be expected in the use field, the hydrophobically or hydrophilically modified additive can be selected.

Comparison of the Storage Stability of Additives Which were Hydrolytically Produced with Additives Produced Non-Hydrolytically According to the Disclosure

The following tables 14a and 14b show test results which confirm the differences between hydrolytically and non-hydrolytically obtained additives attributable to the production method.

TABLE 14a
Analytical data after storage

| | | Example H1 (comparative) | | | | | Example H2 (comparative) | | | | |
|---|---|---|---|---|---|---|---|---|---|---|---|
| Storage at | | Polymethoxysiloxane - | | | | | Polyethoxysiloxane - | | | | |
| 50° C. with | | hydrolytic method | | | | | hydrolytic method | | | | |
| N₂ in weeks | | 0 | 2 | 4 | 8 | 12 | 0 | 2 | 4 | 8 | 12 |
| GPC | MW | 1730 | 1890 | 2173 | 2630 | 2680 | 1207 | 1366 | 1582 | 2057 | 3145 |
| | MP | 384 | 385 | 390 | 377 | 1716 | 311 | 311 | 314 | 305 | 377 |
| | MN | 780 | 804 | 844 | 872 | 728 | 549 | 609 | 619 | 674 | 913 |
| | MZ | 4032 | 4664 | 5710 | 7807 | 7648 | 2647 | 3082 | 3801 | 5535 | 9923 |
| | Mw/Mn | 2.21 | 2.35 | 2.57 | 3.02 | 3.68 | 2.19 | 2.24 | 2.55 | 3.05 | 3.45 |
| Viscosity | at 20° C. | 91 | 93 | 109 | 148 | 197 | 90 | 103 | 117 | 158 | 167 |
| in mPas | | | | | | | | | | | |

TABLE 14b
Analytical data after storage

| | | Example NH2 | | | | |
|---|---|---|---|---|---|---|
| Storage at | | Polyethoxysiloxane - according to the | | | | |
| 50° C. with | | disclosure, non-hydrolytic method | | | | |
| N₂ in weeks | | 0 | 2 | 4 | 8 | 12 |
| GPC | MW | 2104 | 2179 | 2293 | 2267 | 2334 |
| | MP | 1424 | 166 | 168 | 168 | 166 |
| | MN | 731 | 728 | 742 | 714 | 704 |
| | MZ | 4899 | 5136 | 5463 | 5462 | 5784 |
| | Mw/Mn | 2.87 | 2.99 | 3.09 | 3.17 | 3.32 |
| Viscosity | at 20° C. | 49 | 50 | 53 | 54 | 54 |
| in mPas | | | | | | |

GPC

Determination of the molecular weight distribution and determination of the molecular mass mean values Mw, Mn and Mp and the polydispersity (Mw/Mn) in tables 14a and 14b was effected by means of GPC. The was effected by means of gel permeation chromatography with toluene as eluent and using PDMS standards. The column material consists of styrene-divinylbenzene copolymers.

Viscosity

The viscosity in tables 14a and 14b was determined with a plate-cone viscometer from Haake (Roto Visco 1, cone C35/1° Ti gap 0.050 mm) in mPa.sec at 20° C., during which the dependence of the viscosity was studied at a shear rate in a region between 0 and 600 sec⁻¹.

Assessment of the Storage Stability

The gel permeation chromatography shows that the product of example NH2 according to the disclosure, which was produced via a non-hydrolytic route, exhibits a lower viscosity in all cases than the comparison product, even when the product according to the disclosure has a higher molecular weight than the direct comparison product of example H2. This unambiguously confirms that as well as the parameter according to the disclosure of the degree of branching, the production method also has a decisive influence on the product properties and hence the products according to the disclosure also differ structurally from the products which are obtained via the hydrolytic method.

It is also clear that only the product produced according to the disclosure has very great constancy as regards the viscosity and molecular weight over a storage period of 12 weeks at 50° C. under nitrogen, while the hydrolytically obtained products are subject to major changes.

### Application Technology Results (to Examples 15, 16 and 17)

Coating Agents Based on a Thermally Curing Polyester/Melamine Resin System

In accordance with the following table 15, a solvent-based polyester/melamine stoving enamel were produced as starting formulations.

TABLE 15

| Constituents | Formulation | |
|---|---|---|
| Mill base | | |
| Dynapol LH 748^{a} 65% | 22.0 | g |
| Disperbyk 170^{b} | 1.2 | g |
| Solvesso 150 ND^{c} | 7.0 | g |
| Kronos 2310^{d} | 28 | g |
| Let-down | | |
| Dynapol LH 748^{a} 65% | 25.4 | g |
| Cymel 303^{f} | 7.5 | g |
| Dynapol Catalyst 1203^{g} | 4.0 | g |
| Byk-057^{h} | 0.5 | g |
| Butyl diglycol | 1.7 | g |
| Solvesso 150 ND^{c} | 1.3 | g |
| Byk 350ⁱ, 50% in | 1.4 | g |
| Solvesso 150 ND^{c} | | |

^{a}Polyester binder, Evonik, 65% in Solvesso 150 ND
^{b}Wetting agent and dispersant, Byk
^{c}Solvent, ExxonMobil
^{d}Titanium dioxide, Kronos
^{f}Hexamethoxymethylmelamine, Cytec, 100%
^{g}Blocked sulfonic acid derivative, Evonik
^{h}Defoamant, Byk
ⁱLevelling agent, Byk

The mill base was dispersed by means of a Dispermat CV for 20 minutes at 8000 rpm and 40° C. The weight ratio of the mill base to the glass beads was 1:1.

The mill base and the let-down were mixed and homogenized for 5 mins.

In addition, the formulation was matted with 2% Syloid ED 30 (silicic acid matting agent, Grace) (5 mins, 930 rpm).

The viscosity of the formulation was adjusted to 100 to 120 secs (measured with a DIN 4 cup) with Solvesso 150ND.

Subsequently, 1 wt. % or 2 wt. % of the additives from the production examples were incorporated into the formulation, firstly by stirring with a spatula, then with a dissolver for 3 minutes at 1865 rpm with a toothed disk. The percentage weight data corresponds to the quantity of the additive in grams (without any carrier substances or solvents) based on 100 grams of the formulation. The quantities of additives can be obtained from the results tables.

After storage overnight at room temperature, the samples are applied with a spiral applicator in a wet film thickness of 80 μm (corresponds to a dry film thickness of 19-20 μm) onto an Alcan aluminum plate coated with a primer. The coated plates were stoved for 33 seconds in an oven (oven temperature: 320° C.) with a peak metal temperature (PMT) of 232° C.

Test Methods

Soiling Tests on the Cured Formulations

The coating agents were produced as described above. A part of the coating agents was stored overnight at room temperature, a further part for 7 days at 50° C. and a still further part for 14 days at 50° C. Next, the coating agents were applied and cured as stated above. The soiling tests described below (“Carbon Black Test” and “Carbon Black Slurry Test”) were performed directly after application and curing and cooling (“immediate measurement”) or only after 2-week storage at 50° C.

(a) Carbon Black Test (“CB Test”)

The coated plates were dipped five times in the pigment Special Black 4. Then wetted at angle of 45° with water and stored 1 hour at 100° C. Next, the pigment is washed off with water and a soft cloth, so that the loose pigment can be removed. The residues remaining are assessed (1=no residues, 10=major residues).

(b) Carbon Black Slurry Test (“CB Slurry Test”)

The slurry was applied onto the enamel surface with a brush and the plates were stored 1 hour at 100° C. Next, the pigment was washed off with water and a soft cloth, so that the loose pigment can be removed. The residues remaining are assessed (1=no residues, 10=major residues). The carbon black FW 200 slurry had the following composition: 57.6 g water, 26.3 g DISPERBYK®-190 (40%) from Byk-Chemie GmbH, 1.0 g BYK-024 from Byk-Chemie GmbH, 0.1 g Acticide MBS (a biocide from Thor Chemie) and 15.0 g coloring carbon black FW 200 (obtainable from Evonik Industries). The aforesaid components were milled with a Dispermat CV (Teflon blades, 60 minutes, 10000 rpm (18 m/sec), 40° C.). The weight ratio of the mill base to the glass beads (Ø1 mm) was 1:1.

Results

TABLE 16

| | Immediate | | After 2-week storage of | |
|---|---|---|---|---|
| | measurement | | the sample at 50° C. | |
| Control | CB | CB slurry | CB | CB slurry |
| (no additive) | test | test | test | test |
| 1 day at room | 8 | 7 | 9 | 8 |
| temperature | | | | |
| 7 days at 50° C. | 6 | 8 | 6 | 8 |
| 14 days at 50° C. | 6 | 8 | 7 | 8 |

TABLE 17

| | Immediate | | After 2-week storage of | |
|---|---|---|---|---|
| | measurement | | the sample at 50° C. | |
| | CB | CB slurry | CB | CB slurry |
| | test | test | test | test |
| 1% additive (Ex. 15) | | | | |
| 1 day at room | 1 | 8 | 3 | 7 |
| temperature | | | | |
| 7 days at 50° C. | 2-3 | 4 | 2-3 | 3-4 |
| 14 days at 50° C. | 5 | 8 | 4 | 7 |
| 2% additive (Ex. 15) | | | | |
| 1 day at room | 0-1 | 7 | 1 | 7 |
| temperature | | | | |
| 7 days at 50° C. | 1 | 2-3 | 1 | 2-3 |
| 14 days at 50° C. | 2-3 | 4 | 3-4 | 4 |

TABLE 18

| | Immediate | | After 2-week storage of | |
|---|---|---|---|---|
| | measurement | | the sample at 50° C. | |
| | CB | CB slurry | CB | CB slurry |
| | test | test | test | test |
| 1% additive (Ex. 16) | | | | |
| 1 day at room | 1 | 6 | 1-2 | 5 |
| temperature | | | | |
| 7 days at 50° C. | 1-2 | 4 | 1 | 3-4 |
| 14 days at 50° C. | 2 | 5 | 2-3 | 4 |
| 2% additive (Ex. 16) | | | | |
| 1 day at room | 0-1 | 4 | 0-1 | 4 |
| temperature | | | | |
| 7 days at 50° C. | 1-2 | 4 | 0-1 | 4 |
| 14 days at 50° C. | 3 | 5 | 5 | 6 |

TABLE 19

| | Immediate | | After 2-week storage of | |
|---|---|---|---|---|
| | measurement | | the sample at 50° C. | |
| | CB | CB slurry | CB | CB slurry |
| | test | test | test | test |
| 1% additive (Ex. 17) | | | | |
| 1 day at room | 1-2 | 3-4 | 2-3 | 4 |
| temperature | | | | |
| 7 days at 50° C. | 1-2 | 3 | 2 | 3 |
| 14 days at 50° C. | 1-2 | 2-3 | 2 | 3 |
| 2% additive (Ex. 17) | | | | |
| 1 day at room | 0-1 | 4 | 1-2 | 4 |
| temperature | | | | |
| 7 days at 50° C. | 1 | 4 | 1-2 | 4 |
| 14 days at 50° C. | 1-2 | 4 | 1-2 | 4 |

From the results in table 15 to 19 it can be seen that the addition of the hyperbranched polyalkoxysiloxane (polydimethylsiloxane-modified hyperbranched polyethoxy-siloxane of examples 15 and 16 and especially the poly-ethylene glycol block-polydimethylsiloxane-modified hyperbranched polyalkoxysiloxane of example 17) greatly improves the self-cleaning properties of the coating agent composition. Both in the CB test and also in the CB slurry test, the surfaces were easy to clean by water rinsing. The self-cleaning properties were not adversely affected even in the presence of a leveling agent of the polyacrylate type (BYK 350). Leveling agents of the polyacrylate type, on account of their low glass transition temperature, are known to make surfaces somewhat more susceptible to adhering dirt.

Application Technology Comparison of Coating Agent Compositions to which Non-Hydrolytically or Hydrolytically Produced Additives had been Added

The following tables 20 to 23 show that use of the non-hydrolytically produced additive as opposed to a hydrolytically produced additive leads to coatings which display markedly superior soiling resistance.

A part of the additives was used in the coating agent directly after their synthesis, a further part was stored for 2 months at 50° C. before used in the coating agent. The other data correspond to the definitions from tables 15 to 19.

TABLE 20

| | Immediate | | After 2-week storage of | |
|---|---|---|---|---|
| | measurement | | the sample at 50° C. | |
| | CB | CB slurry | CB | CB slurry |
| Control (no additive) | test | test | test | test |
| 1 day at room | 8 | 7 | 9 | 8 |
| temperature | | | | |
| 7 days at 50° C. | 6 | 8 | 6 | 8 |
| 14 days at 50° C. | 6 | 8 | 7 | 8 |

TABLE 21

| | Immediate | | After 2-week storage of | |
|---|---|---|---|---|
| | measurement | | the sample at 50° C. | |
| | CB | CB slurry | CB | CB slurry |
| | test | test | test | test |
| 1% additive (Ex. H1) | | | | |
| 1 day at room | 4 | 3 | 4-5 | 4 |
| temperature | | | | |
| 7 days at 50° C. | 6 | 7 | 5 | 7 |
| 14 days at 50° C. | 5 | 8 | 9 | 8 |
| 2% additive (Ex. H1) | | | | |
| 1 day at room | 4 | 3 | 5 | 3 |
| temperature | | | | |
| 7 days at 50° C. | 5 | 7 | 5 | 7 |
| 14 days at 50° C. | 6 | 8 | 6 | 8 |
| 1% additive (Ex. H1) | | | | |
| 2 months | | | | |
| 1 day at room | 4 | 3 | 6 | 4 |
| temperature | | | | |
| 7 days at 50° C. | 6 | 8 | 6 | 7 |
| 14 days at 50° C. | 5 | 7 | 8 | 8 |
| 2% additive (Ex. H1) | | | | |
| 2 months | | | | |
| 1 day at room | 4 | 3 | 4-5 | 4 |
| temperature | | | | |
| 7 days at 50° C. | 5 | 7 | 5 | 7 |
| 14 days at 50° C. | 6 | 7 | 7 | 8 |

TABLE 22

| | Immediate | | After 2-week storage of | |
|---|---|---|---|---|
| | measurement | | the sample at 50° C. | |
| | CB | CB slurry | CB | CB slurry |
| | test | test | test | test |
| 1% additive (Ex. NH2) | | | | |
| 1 day at room | 1 | 4 | 3 | 6 |
| temperature | | | | |
| 7 days at 50° C. | 1 | 5 | 1-2 | 4-5 |
| 14 days at 50° C. | 2-3 | 5 | 5 | 6 |
| 2% additive (Ex. NH2) | | | | |
| 1 day at room | 1 | 7 | 5 | 6 |
| temperature | | | | |
| 7 days at 50° C. | 1-2 | 4 | 1-2 | 4 |
| 14 days at 50° C. | 1-2 | 5 | 3 | 5 |
| 1% additive (Ex. NH2) | | | | |
| 2 months | | | | |
| 1 day at room | 2 | 6 | 3 | 6 |
| temperature | | | | |
| 7 days at 50° C. | 1-2 | 4 | 1 | 3-4 |
| 14 days at 50° C. | 2 | 4 | 4 | 5 |
| 2% additive (Ex. NH2) | | | | |
| 2 months | | | | |
| 1 day at room | 1 | 5 | 2-3 | 5 |
| temperature | | | | |
| 7 days at 50° C. | 2 | 5 | 1-2 | 3-4 |
| 14 days at 50° C. | 2 | 4 | 3 | 4 |

TABLE 23

| | Immediate | | After 2-week storage of | |
|---|---|---|---|---|
| | measurement | | the sample at 50° C. | |
| | CB | CB slurry | CB | CB slurry |
| | test | test | test | test |
| 1% additive (Ex. H2) | | | | |
| 1 day at room | 3 | 7 | 3 | 5 |
| temperature | | | | |
| 7 days at 50° C. | 7 | 7 | 5 | 6 |
| 14 days at 50° C. | 7 | 8 | 8 | 8 |
| 2% additive (Ex. H2) | | | | |
| 1 day at room | 3 | 7 | 3 | 4 |
| temperature | | | | |
| 7 days at 50° C. | 4 | 6 | 4 | 5 |
| 14 days at 50° C. | 4 | 7 | 5 | 7 |
| 1% additive (Ex. H2) | | | | |
| 2 months | | | | |
| 1 day at room | 4 | 8 | 4 | 6 |
| temperature | | | | |
| 7 days at 50° C. | 5 | 7 | 4 | 5 |
| 14 days at 50° C. | 5 | 8 | 5 | 9 |
| 2% additive (Ex. H2) | | | | |
| 2 months | | | | |
| 1 day at room | 4 | 8 | 3 | 7 |
| temperature | | | | |
| 7 days at 50° C. | 4-5 | 7 | 4-5 | 6 |
| 14 days at 50° C. | 4-5 | 7 | 5 | 8 |

The application technology experiments also show that the additives produced by the subject method (example NH2) are superior to the additives of the state of the art (Examples H1 and H2). The additives according to the disclosure are storage-stable even over several months at elevated temperatures (50° C.). This is clearly evident from the coatings produced therefrom, since these furthermore exhibit high soiling resistance. The coatings produced using the additives according to the disclosure also exhibit marked long-term resistance to soiling, in particular after storage of the coated substrates. Overall, the above experiments show that the non-hydrolytically produced additives according to the disclosure as such are more storage-stable than the hydrolytically produced additives. In addition, the coating agents produced with the additives according to the disclosure are more storage-stable and the coated substrates produced from the coating agents exhibit better and also more long-term stable soiling resistance. The results thus also confirm that the non-hydrolytically produced additives according to the disclosure are to be structurally distinguished from the hydrolytically obtained additives, since the fundamentally different properties are only thus explainable.

Although the embodiments have been described in detail through the above description and the preceding examples, these examples are for the purpose of illustration only and it is understood that variations and modifications can be made by one skilled in the art without departing from the spirit and the scope of the disclosure. It should be understood that the embodiments described above are not only in the alternative, but can be combined.

1. A coating agent composition comprising
(A) 0.1 to 10 wt. %, based on the coating agent composition, of a fluorine-free polyalkoxysiloxane which
(a) has a degree of branching DB≧0.4, which is calculated according to the following formula:
DB=(2Q⁴+Q³)/(2Q⁴+4/3Q³+2/3Q²)
wherein Qⁿ for n=0 to 4 are determined by ²⁹Si NMR and Qⁿ for n=0 to 4 in each case stands for the area under the ²⁹Si NMR signal of a (4-n)-fold alkoxylated Si atom and the sum of the Qⁿ with n=0 to 4 is normalized to 100%,
and
(b) the polyalkoxysiloxane is produced by a non-hydrolytic polycondensation process,
(B) at least one synthetic polymer selected from the group consisting of physically drying, self-crosslinking reactive or co-crosslinking reactive synthetic polymers which are different from (A), and
(C) in the case that (B) is a co-crosslinking reactive synthetic polymer, a crosslinker different from (A) and (B).

2. The coating agent composition as in claim 1, wherein the fluorine-free polyalkoxysiloxane has a weight average molecular weight from 1000 to 7000 g/mol.

3. The coating agent composition as in claim 1, wherein the non-hydrolytic polycondensation process is effected using monomeric alkoxysilanes and/or oligomeric alkoxysiloxanes of the formula (I): 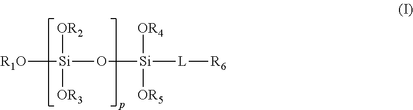
wherein R₁, R₂, R₃, R₄ and R₅ independently of one another are linear or branched alkyl groups with 1 to 4 carbon atoms,
p stands for a whole number from 0 to 15,
L stands for oxygen or a divalent linking group, and
R₆ independently stands for a linear or branched alkyl group with 1 to 5 carbon atoms, polyalkyleneoxy group, polysiloxane group, polyalkyleneoxy-polysiloxane group, isocyanate group, epoxy group, amino group, vinyl group, allyl group or (meth)acryl group.

4. The coating agent composition as in claim 1, wherein the fluorine-free polyalkoxysiloxane produced by the non-hydrolytic poly-condensation process is reacted by transalkoxylation with one or more compounds selected from the group of monohydroxy functional alcohols, monohydroxy functional polyethers, monohydroxy functional polysiloxanes and monohydroxy polyether modified polysiloxanes.

5. The coating agent composition as in claim 1, wherein the (B) synthetic polymer is co-crosslinking and is selected from the group of the polyhydroxy functional polyesters, polyhydroxy functional polyurethane resins, polyhydroxy functional acrylic resins, polyhydroxy functional fluorinated resins, silicone resins, epoxy resins and radiation curable resins.

6. The coating agent composition as in claim 5, containing as crosslinker (C) a free or blocked polyisocyanate, an aminoplast resin, a melamine resin, a hydroxyalkylamide, a radiation curable reactive diluent or mixtures thereof.

7. The coating agent composition as in claim 1, comprising a powder enamel or a coil coating enamel.

8. A solid, encapsulated additive, comprising
(i) at least one fluorine-free polyalkoxysiloxane which
(a) has a degree of branching DB≧0.4, which is calculated according to the following formula:
DB=(2Q⁴+Q³)/(2Q⁴+4/3Q³+2/3Q²)
wherein Qⁿ for n=0 to 4 are determined by ²⁹Si NMR and Qⁿ for n=0 to 4 in each case stands for the area under the ²⁹Si NMR signal of a (4-n)-fold alkoxylated Si atom and the sum of the Qⁿ with n=0 to 4 is normalized to 100%,
and
(b) the polyalkoxysiloxane is produced by a non-hydrolytic polycondensation process,
and
(ii) at least one polymer which serves for the encapsulation of the fluorine-free polyalkoxysiloxane.

9. The solid, encapsulated additive as in claim 8, wherein the fluorine-free polyalkoxysiloxane has a weight average molecular weight from 1000 to 7000 g/mol.

10. The solid, encapsulated additive as in claim 8, wherein the non-hydrolytic polycondensation process is effected using monomeric alkoxysilanes and/or oligomeric alkoxysiloxanes of the formula (I): 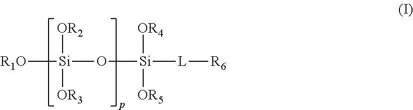
wherein R₁, R₂, R₃, R₄ and R₅ independently of one another are linear or branched alkyl groups with 1 to 4 carbon atoms,
p stands for a whole number from 0 to 15,
L stands for oxygen or a divalent linking group, and
R₆ independently stands for a linear or branched alkyl group with 1 to 5 carbon atoms, polyalkyleneoxy group, polysiloxane group, polyalkyleneoxy-polysiloxane group, isocyanate group, epoxy group, amino group, vinyl group, allyl group or (meth)acryl group.

11. The solid, encapsulated additive as in claim 8, wherein the fluorine-free polyalkoxysiloxane produced by the non-hydrolytic poly-condensation process is reacted by transalkoxylation with one or more compounds selected from the group of monohydroxy functional alcohols, monohydroxy functional polyethers, monohydroxy functional polysiloxanes and monohydroxy polyether modified polysiloxanes.

12. The solid, encapsulated additive as in claim 8, obtained by
dissolution of (i) and (ii) in a nonpolar solvent,
addition of a solution of (i) and (ii) to a polar solvent which contains an emulsifier,
removal of the nonpolar solvent and
separation of the solid, encapsulated additive.

13. The solid, encapsulated additive as in claim 8, containing at least 50 wt. % of (i) based on the total weight of the additive.

14. A solid, freeze-dried additive, comprising
(i) at least one fluorine-free polyalkoxysiloxane which
(a) has a degree of branching DB≧0.4, which is calculated according to the following formula:
DB=(2Q⁴+Q³)/(2Q⁴+4/3Q³+2/3Q²)
wherein Qⁿ for n=0 to 4 are determined by ²⁹Si NMR and Qⁿ for n=0 to 4 in each case stands for the area under the ²⁹Si NMR signal of a (4-n)-fold alkoxylated Si atom and the sum of the Qⁿ with n=0 to 4 is normalized to 100%,
and
(b) the polyalkoxysiloxane is produced by a non-hydrolytic polycondensation process,
and
(ii) at least one polymer, and which is produced by
(iii) production of a solution of (i) and (ii) in a suitable solvent and
(iv) removal of the solvent by freeze-drying.

15. The solid, freeze-dried additive as in claim 14, wherein the fluorine-free polyalkoxysiloxane has a weight average molecular weight from 1000 to 7000 g/mol.

16. The solid, freeze-dried additive as in claim 14, wherein the non-hydrolytic polycondensation process is effected using monomeric alkoxysilanes and/or oligomeric alkoxysiloxanes of the formula (I): 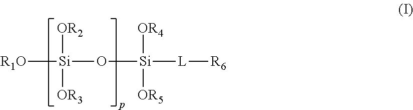
wherein R₁, R₂, R₃, R₄ and R₅ independently of one another are linear or branched alkyl groups with 1 to 4 carbon atoms,
p stands for a whole number from 0 to 15,
L stands for oxygen or a divalent linking group, and
R₆ independently stands for a linear or branched alkyl group with 1 to 5 carbon atoms, polyalkyleneoxy group, polysiloxane group, polyalkyleneoxy-polysiloxane group, isocyanate group, epoxy group, amino group, vinyl group, allyl group or (meth)acryl group.

17. The solid, freeze-dried additive as in claim 14, wherein the fluorine-free polyalkoxysiloxane produced by the non-hydrolytic poly-condensation process is reacted by transalkoxylation with one or more compounds selected from the group of monohydroxy functional alcohols, monohydroxy functional polyethers, monohydroxy functional polysiloxanes and monohydroxy polyether modified polysiloxanes.

18. The solid, freeze-dried additive as claimed in claim 14, characterized in that at least 50 wt. % of (i) based on the total weight of the additive is contained.

19. A solid wax-containing or waxy substances-containing additive, comprising
(i) at least one fluorine-free polyalkoxysiloxane which
(a) has a degree of branching DB≧0.4, which is calculated according to the following formula:
DB=(2Q⁴+Q³)/(2Q⁴+4/3Q³+2/3Q²)
wherein Qⁿ for n=0 to 4 are determined by ²⁹Si NMR and Qⁿ for n=0 to 4 in each case stands for the area under the ²⁹Si NMR signal of a (4-n)-fold alkoxylated Si atom and the sum of the Qⁿ with n=0 to 4 is normalized to 100%,
and
(b) the polyalkoxysiloxane is produced by a non-hydrolytic polycondensation process,
and
(ii) at least one wax or a waxy substance, and which is produced by
(iii) melting the wax or the waxy substance,
(iv) addition of (i), and then
(v) cooling and
(vi) optionally pelleting or granulation.

20. The solid wax-containing or waxy substances-containing additive as in claim 19, wherein the fluorine-free polyalkoxysiloxane has a weight average molecular weight from 1000 to 7000 g/mol.

21. The solid wax-containing or waxy substances-containing additive as in claim 19, wherein the non-hydrolytic polycondensation process is effected using monomeric alkoxysilanes and/or oligomeric alkoxysiloxanes of the formula (I): 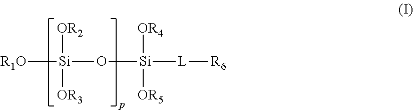
wherein R₁, R₂, R₃, R₄ and R₅ independently of one another are linear or branched alkyl groups with 1 to 4 carbon atoms,
p stands for a whole number from 0 to 15,
L stands for oxygen or a divalent linking group, and
R₆ independently stands for a linear or branched alkyl group with 1 to 5 carbon atoms, polyalkyleneoxy group, polysiloxane group, polyalkyleneoxy-polysiloxane group, isocyanate group, epoxy group, amino group, vinyl group, allyl group or (meth)acryl group.

22. The solid wax-containing or waxy substances-containing additive as in claim 19, wherein the fluorine-free polyalkoxysiloxane produced by the non-hydrolytic poly-condensation process is reacted by transalkoxylation with one or more compounds selected from the group of monohydroxy functional alcohols, monohydroxy functional polyethers, monohydroxy functional polysiloxanes and monohydroxy polyether modified polysiloxanes.

23. The solid wax-containing or waxy substances-containing additive as in claim 19, containing at least 50 wt. % of (i) based on the total weight of the additive.

24. A method for coating a substrate selected from the materials metal, glass, ceramic and plastic, wherein the coating agent composition as in claim 1 is applied onto a substrate and is crosslinked by physical drying, reactive self-crosslinking or reactive co-crosslinking and/or the crosslinking takes place thermally at a temperature of >100° C.

25. A cured coating obtained by the method as in claim 24.

26. The cured coating as in claim 25, wherein after implementation of the method, an at least partial hydrolytic crosslinking of the hyperbranched polyalkoxysiloxane has been effected with formation of a silicic acid network.

27. A process comprising incorporating a fluorine-free polyalkoxysiloxane, which
(a) has a degree of branching DB≧0.4, which is calculated according to the following formula:
DB=(2Q⁴+Q³)/(2Q⁴+4/3Q³+2/3Q²)
wherein Qⁿ for n=0 to 4 are determined by ²⁹Si NMR and Qⁿ for n=0 to 4 in each case stands for the area under the ²⁹Si NMR signal of a (4-n)-fold alkoxylated Si atom and the sum of the Qⁿ with n=0 to 4 is normalized to 100%,
and
(b) the polyalkoxysiloxane is produced by means of a non-hydrolytic polycondensation process,
as an additive in a coating agent composition in a quantity from 0.1 to 10 wt. % based on the total weight of the coating agent composition,
wherein the coating agent composition contains at least one synthetic polymer selected from the group consisting of physically drying, self-crosslinking reactive or co-crosslinking reactive synthetic polymers which are different from the fluorine-free polyalkoxysiloxane, and
in the case that the at least one synthetic polymer is a co-crosslinking reactive synthetic polymer, the coating agent composition contains a crosslinker different from the fluorine-free polyalkoxysiloxane and from the co-crosslinking synthetic polymer.

28. The process as in claim 27, wherein the fluorine-free polyalkoxysiloxane has a weight average molecular weight from 1000 to 7000 g/mol.

29. The process as claimed in claim 27, wherein the non-hydrolytic polycondensation method is effected using monomeric alkoxysilanes and/or oligomeric alkoxysiloxanes of the formula (I): 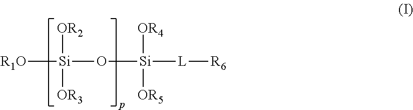
wherein R₁, R₂, R₃, R₄ and R₅ independently of one another are linear or branched alkyl groups with 1 to 4 carbon atoms,
p stands for a whole number from 0 to 15,
L stands for oxygen or a divalent linking group, and
R₆ independently stands for a linear or branched alkyl group with 1 to 5 carbon atoms, polyalkyleneoxy group, polysiloxane group, polyalkyleneoxy-polysiloxane group, isocyanate group, epoxy group, amino group, vinyl group, allyl group or (meth)acryl group.

30. The process as in claim 27, wherein the fluorine-free polyalkoxysiloxane produced by the non-hydrolytic poly-condensation reaction is reacted by transalkoxylation with one or more compounds selected from the group of the monohydroxy functional alcohols, monohydroxy functional polyethers, monohydroxy functional polysiloxanes or monohydroxy polyether modified polysiloxanes.
